(19) United States
(12) Patent Application Publication
(10) Pub. No.: US 2026/0240190 A1
(43) Pub. Date: Aug. 20, 2026

(54) USES OF COCA LEAF OR VALERIAN ROOT TO REDUCE BITTERNESS IN PLANT-BASED FOODS SUCH AS THOSE CONTAINING UNSWEETENED COCOA

(71) Applicant: Gregory AHARONIAN, Belmont, MA (US)

(72) Inventor: Gregory AHARONIAN, Belmont, MA (US)

(21) Appl. No.: 19/445,030

(22) Filed: Jan. 9, 2026

Related U.S. Application Data
(63) Continuation of application No. 17/727,370, filed on Apr. 22, 2022, now abandoned.
Application No. 17/727,370 is a continuation of application No. 15/442,628, filed on Feb. 25, 2017, now abandoned.
Application No. 15/442,628 is a continuation of application No. 14/744,242, filed on Jun. 19, 2015, now abandoned.
Application No. 14/744,242 is a continuation-in-part of application No. PCT/US15/12536, filed on Jan. 22, 2015.
Application No. PCT/US15/12536 is a continuation-in-part of application No. PCT/US14/48299, filed on Jul. 25, 2014.
(60) Provisional application No. 62/107,353, filed on Jan. 24, 2015.

(51) Int. Cl. A23G 1/48; A23G 1/36; A23G 1/44

(52) U.S. Cl. CPC A23G 1/48; A23G 1/36; A23G 1/44; A23V 2002/00

(57) ABSTRACT

Products that are sugar-free, or are low in sugar (or low in artificial sweeteners), are disclosed herein that comprise extracts from the leaves of the Erythroxylum plant, and one or more plant products, such as cocoa powder, wherein the perceived bitterness of the plant product(s) is reduced. Extracts from other plants, such as Hibiscus and Valerian root, can be used to reduce perceived bitterness.

### CROSS-REFERENCE TO RELATED APPLICATIONS

This patent application is a continuation under 35 U.S.C. § 120 of U.S. patent application Ser. No. 17/727,370, filed 22 Apr. 2022, which is a continuation of U.S. patent application Ser. No. 15/442,628, filed 25 Feb. 2017, which is a continuation under 35 U.S.C. § 120 of U.S. patent application Ser. No. 14/744,242, filed 19 Jun. 2015, which claims priority benefit 35 U.S.C. § 371 to International Patent Applications Nos. PCT/US 14/48299, filed on 25 Jul. 2014, and PCT/ US 15/12536, filed 22 Jan. 2015 and under 35 U.S.C. § 119(e) to provisional U.S. patent application Ser. No. 62/107,353, filed 24 Jan. 2015. The contents of each of the aforementioned patent applications is incorporated herein by reference in its entirety and for all purposes.

### UTILITY AND MORALITY

Some embodiments of the invention disclosed herein make use of the leaves of the coca plant (or equivalents), which could raise issues of public utility and morality. For example, European Patent Convention article 53(a) prohibits patents that “would be contrary to ‘order public’ or morality”. Regular dietary consumption of coca leaf products is not addictive and not medically detrimental (a fact consistent with the suppressed 1995 U.N. study on use of coca leaves), and extreme consumption is orders less addictive than the consumption of products that contain nicotine, sugar, alcohol, prescription opioids, and prescription amphetamines. As, Evo Morales, the president of Bolivia poetically, and accurately states, “Coca leaf is to cocaine, as grapes are to wine.” President Morales wants to help cure diabetes and epilepsy with coca leaves—let's help!

### BACKGROUND OF THE INVENTION

The reference to, or discussion of, any prior-published document or any other historical or factual background in this specification is in no way an acknowledgement that the document or background necessarily is prior art. All references described herein are incorporated by reference in their entirety.

### Chocolate, Kuna Indians, and a Long and Healthy Life

### Cocoa/Cacao—Wonder Drug Of 21st Century.

Except as noted below, the word “cocoa” and its Spanish equivalent, “cacao”, are used interchangeably herein. In addition, unless otherwise indicated the word “or” is used herein in its non-exclusive sense, e.g., “A or B” can refer to either A only, B only, or A and B taken in combination.

While cocoa contains caffeine (along with many nutrients such as flavonols, and flavor compounds [see Schieb2000]), one important alkaloid it contains is a homologue of caffeine, theobromine (the free tertiary amine in theobromine is methylated in caffeine.). Generally, cocoa powder comprises between about 2% to about 10% of theobromine.

In recent years, various studies have shown that consumption of cocoa can result in decreases in the rates of heart disease, cancer, diabetes and other health problems (see Franco 2013). A study published in Caries Research in 2015 reported that theobromine is as effective as fluorine in the remineralization of teeth and in fighting tooth decay (see Amae2013). Another study published in Molecular Nutrition & Food Research in 2015 reported that cocoa intake, at least in rats, may delay progression of type 2 diabetes (see Fernan2015). Another study published in 2008 reported that drinking two cups of hot chocolate a day may help older people increase blood flow in the brain (see Sorond 2008), with a 2014 study showing that a high cocoa diet improves cognition in older adults (see Brick 2014). Another study published in 2010 reported that theobromine-enriched cocoa lowered central systolic blood pressure (see Bogard2010). Levels of theobromine higher than natural in chocolate are known to act as a diet suppressant. Another study published in 2007 reported that regular consumption of dark chocolate that is rich in flavonols can lower arterial stiffness (see Vlach2007), while U.S. Pat. No. 6,900,241 claims use of cocoa to treat atherosclerosis. Another study published in 2013 reported that theobromine seems to be the chemical in cocoa whose consumption leads to increases in serum-HDL (the so-called “good” cholesterol) concentrations (see Neufin2013). Mars, the chocolate company, has patented the use of some cocoa extracts as anti-tumor agents (see U.S. Pat. No. 7,820,713). Similarly, another chocolate company, Barry Callebaut, has patented the use of some cocoa extracts for treating prostate cancer (see U.S. Pat. No. 8,435,576). Also, recent studies have raised the question of whether people have too much added iron in their diets, and if this added iron is contributing to a variety of health problems such as heart disease and increased inflammation. Cocoa is known to decrease iron absorption while eating. In 2007, scientists in Panama studied the country's Kuna Indians, who consume large amounts of cocoa, typically consuming, each day, approximately 900 milligrams of flavonols in cocoa, as well as much theobromine. The result of the study was that deaths due to heart disease and cancer dropped by a factor of ten, and deaths due to diabetes dropped by a factor of four (see Bayard2007). While these effects cannot be solely attributed to the cocoa diet, there is a positive health contribution from this consumption of cocoa. More offbeat uses of cocoa include being used to make suppositories—a mix of cocoa butter and 2% menthol.

### Cocoa, Saturated Fats, Carbohydrates and the Global Obesity and Diabetes Crisis.

In the 1970s, based on statistically unreliable data, the U.S. government dictated that a healthy food diet should be low in fats (think of the host of low-fat and no-fat products), and high in carbohydrates (low/no fat products often have lots of sugar), for example as discussed in “The Big Fat Surprise” by Nina Teicholz. Result? Since then, rates of obesity in the United States have more than doubled, and diabetes has become a $1 trillion per year global health problem. Much demonized has been saturated fat, even though studies show that, at a minimum, saturated fats don't pose much of a health threat if not consumed in excess (as compared to consuming high sugar/carbohydrate diets), and if anything, provides benefits such as raising “good” HDL cholesterol levels, while the mono-unsaturated fats can help lower “bad” LDL. One very healthy source of saturated fats is cacao butter, a good source of stearic acid, which has minimal impact on cholesterol levels. Such fats become a health problem when consumed with sugars (see Volk2014).

Theobromine, flavonols and saturated fats, with their disease reduction properties, makes cocoa an ideal natural medicine that is also an inexpensive food-a nutraceutical. Any medicine having the biological properties of cocoa would be eagerly adopted by millions of people around the world, because everyone loves the popular form of cocoa, chocolate. But there is a problem: Raw cocoa has a very bitter taste, which makes regular consumption difficult and unpleasant, and the main solution is to use an addictive chemical that is becoming the next “cocaine”—sugar (see FIG. 2).

Indeed, to have a pleasant taste, most forms of cacao that are consumed are chocolate products that are rich in sugar (see FIG. 1). The great historic need for sugar to make cacao into consumable chocolate, if not a medical, product, dates back over 200 years. In 1796, in his book, “Tratado de Los Usos, Abusos, Propiendades y Virtudes del Tabaco, Caf\acute{e}, Te y Chocolate” (published in Madrid, Spain), Antonio Lavedan included a recipe for “Health Chocolate”, part of which includes the following instructions: “[Toast cacao pods in heated sand]. . . It is better to toast it this way . . . and third, more importantly, the fatty, oily and volatile parts of the cacao are not dissipated. . . . The miller smashes and grinds the cacao . . . thereby making a paste which is then mixed with one-half or third parts sugar”. With the addition of fat from the presence of cacao butter in the mixture, you have the typical greater-than 50% quantity of sugar and fat that is seen even today in modern day chocolate products.

The bitterness of cocoa is so great that Hershey's recipe for “Perfectly Chocolate” hot cocoa recommends, for two such tablespoons of cocoa powder, adding two tablespoons of sugar and one cup of milk (which adds additional sugar, and some fat) to reduce bitterness. The American Heart Association recommends about 2 tablespoons (25 grams) of sugar per day for women and girls, and 3 tablespoons a day (38 grams) for men and boys, as total consumption of sugar from all foods. Eating just one chocolate product in FIG. 1 per day, or drinking a cup of hot chocolate, can come close to this total limit.

The sugar used to make cocoa palatable is known to be damaging to health when consumed in large quantities, thereby cancelling the benefits of cocoa's flavonols and theobromine. A study published in 2012 by the American Diabetes Association estimated that 20% of all of the money spent in the United States for health care is spent on people with diagnosed diabetes, 60% of the costs of which are paid for by the United States government One major cause of diabetes, especially type 2 (adult-onset) diabetes is over-consumption of an addictive food drug (see FIG. 2), sugar, especially sugar that is added to popular consumer drinks such as sodas and fruit juices, and consumption of artificial sweeteners that can induce future consumption of sugar.

Sugar free, fat-free forms of cocoa, such as HERSHEY'S UNSWEETENED COCOA®, are very bitter to taste or drink, making mass consumption literally unpalatable. In most supermarkets, the shelf space devoted to unsweetened cocoa products is a small fraction of the shelf devoted to chocolate products with much sugar. In most nutritional supplement stores, such as those licensed under the tradename “GNC”, there are very few, if any, products containing ample amounts of cocoa for its coronary, diabetic or cancer health benefits. Others have failed to create chocolate products that use sweeteners and fats as embellishments, as opposed to being essential ingredients. All of these failures, despite the tremendous funds available in the $100 billion chocolate industry, illustrate the need for new ways to experience the health benefits of cocoa without its bitterness.

### Failures Of Sugar Substitutes To Displace Use Of Sugar

Companies such as Coca Cola and Pepsi (which control one third of the global market for soft drinks) would be just as glad to make all of their profits from selling sweetener-free sodas and juices, as contrasted to obtaining most of their profits from selling diabetes-inducing, sugar-based (typically the metabolically controversial corn-based fructose) sodas and juices (in 2013, the top five officers of Coca-Cola and of PepsiCo jointly earned $104 million, much for selling fructose soda). There is no business conspiracy here, but rather an extremely complicated problem of biochemical engineering—how do you make a chemical substitute that tastes mostly like sugar, but isn't sugar, especially a profitable substitute that is not bitter, that is not cancerous, that is not addictive, and/or is not toxic?

For chocolate, this failure of others is discussed in a journal article, “Industrial manufacture of sugar-free chocolates—applicability of alternative sweeteners and carbohydrate polymers as raw materials in product development” [see Aidoo2013]. One problem for the $100 billion chocolate industry (for which use of sweeteners and fats is essential) seeking increased sales of cocoa due to the growing recognition of its health benefits, is to find a solution for developing cocoa-based food products for which sweeteners are inessential.

### Artificial Sweeteners

For over 50 years, beverage and flavoring companies have been trying to make sugar inessential by substitution with chemicals having similar sweetness but metabolically more favorable properties. While many alternatives are chemically interesting, some commercially successful, all have failed to fully replace sugar. Starches are just sugars with delayed onset. The sugar alcohols (sorbitol, maltitol, xylitol, erythitol, polyglycitol, isomalitol, etc.—all a class of polyols), while tasty, have a tendency to cause gastric distress (flatulence, diarrhea, etc.) when consumed in quantity (limiting the popularity of their use, e.g., in chocolate products (see, e.g., U.S. Pat. No. 5,490,996)). The artificial sweeteners have their failures. Cyclamates were banned for being cancerous and are slightly bitter. Saccharin was banned (then approved) for being cancerous and is slightly bitter. Dulcin was banned for being cancerous though isn't bitter. Aspartame (better known as NUTRASWEET® or EQUAL®) is commercially popular, has a slight bitter taste (as does a related sweetener, neotame), and can be of harm to those suffering from phenylketonuria (a harm shared with a new relative, advantame). Sucralose (better known as SPLENDA®) has health concerns (it is an organochlorine, as is DDT and dioxin) and impurity concerns (presence of lead and arsenic at microgram levels). Another popular sweetener, acesulfame, has its impurity concerns (presence of methylene chloride, a carcinogenic solvent used during manufacturing) and like the banned cyclamates and saccharin, it contains a sulfur atom that contributes bitterness.

Another group of sweeteners that have failed to displace sugar are plant-derived. Neohesperidin dihydrochalcone, derived from citrus plants, while approved in Europe has not been approved in the United States (one problem is that under some conditions it causes nausea and migraines). Glycirrhizin (derived from licorice root) is sweet, though not typically used as a sweetener. Stevia (in particular the glycoside Rebaudioside A, “Reb-A”) is the latest “fad” sugar, though has its bitterness problems. Reb A is bitter in large amounts; indeed one patent, U.S. Pat. No. 8,119,821, claims use of an artificial sweetener to make stevia less bitter, while the structurally related sweeter Rebaudioside-D (“Reb-D”) is expensive because it occurs in small amounts, and was originally banned by the FDA for being possibly carcinogenic. Other trending sweeteners from plants, little used so far, are mogrosides derived from the monk fruit (popular in China), monatin derived from a South African shrub, and miraculin from the fruit of Synsepalum dulcificum (which temporarily turns sour tastes into sweet tastes).

### Artificial Sweeteners, Weight Gain and Pollution

Beyond using artificial sweeteners to avoid the diabetes-inducing effects of sugar consumption, is the desire to use artificial sweeteners to avoid the weight-gaining effects of sugar consumption. Ironically, in 2013, Susan Swithers of Purdue University, argued that in some cases, artificial sweeteners can lead to weight gain, by disturbing the brain's and body's ability to count calories, thus causing the consumer to eat more sugared products to get the dopamine and calories that the artificial sweeteners don't provide (see Swith2013). Another danger posed by artificial sweeteners is that of polluting the environment. Artificial sweeteners are mostly not broken down in the body when consumed, and only partially eliminated in wastewater treatment plants, the remainder of which is polluting rivers and lakes.

### Bitter Blockers

Much work has gone into developing chemicals that block bitterness, while not necessarily adding sweetness. While there are some very effective bitter blockers, they are not used commercially, because of the difficulty and/or high cost of obtaining or producing these chemicals. These chemicals include riboflavin binding protein, phosphatidic acid—beta—lactoglobulin (PA-LG) (known since the 1990s), and neodiosmin. Or artificial bitter blockers have proven not to be commercially useful, for example, U.S. Pat. No. 6,942,874 (issued to Linguagen in 2005) for a bitter blocker based on uridine 5′-monophosphate, a derivative of the naturally occurring adenosine 5′-monophosphate, which partially blocks bitterness but also has not seem much use commercially (see U.S. Pat. No. 6,540,978). Or natural bitter blockers have proven not to be commercially useful, for example, PCT Publication WO 2010141889 (filed by Biogenics Innovations in 2010) for a bitter blocker based on a dietary supplement, methylsulfonylmethane. Or natural bitter blockers have not seemed to be of much use commercially, for example, ferulic acid and caffeic acid as claimed in U.S. Pat. No. 5,336,513.

### Failure to Use Erythroxylum Extracts Other Than As a Stimulant

For thousands of years, indigenous people of the Andean regions of South America have chewed on coca leaves (plant genus Erythroxylum, some strains of which are Erythroxylum coca (much grown in Bolivia, in particular, in the Yungas and Chapare regions) and Erythroxylum novogranatense (much grown in Peru and Colombia)), and have drunk coca tea (mate de coca), both of which can lead to absorption of one or more coca alkaloids, a mild stimulant to the human body, a stimulus similar to a cup of coffee or green/black tea (a cup of mate de coca contains about five to eight milligrams of organic coca alkaloids, most broken down in the stomach). The mild stimulation of coca leaf is due in part to the main coca alkaloid, benzoylmethylecgonine. Mate de coca is (legally) sold in Peru, Bolivia, y Colombia, and can be bought in Chile, Argentina y Ecuador. Much information on the history and chemistry of coca leaf is available at: http://www.cienciadelacoca.org.

What others have failed to do is to use Erythroxylum extracts and derivatives for non-stimulant purposes that are significant, for example, to manufacture food products with significant medical benefits, and that are commercially successful. U.S. Pat. No. 4,696,819 teaches using alkaloid-free coca leaf extracts as an appetite suppressant, but there is little evidence it had any commercial success. What little technology has been developed for preparing coca leaf extracts teaches away from using the alkaloids in the extract by removing the coca alkaloids, for example, U.S. Pat. No. 4,956,429 (“Method of making a coca leaf extract” . . . for cola beverages). This failure of others includes not recognizing the use of one or more Erythroxylum extracts as a debittering agent (i.e., bitter inhibiting, bitter blocker, bitter masking) for consumer food products. A 2011 thesis nowhere mentions the use of Erythroxylum extracts as a debittering agent for functional beverages such as cocoa (see Gande 2017). This failure of others has led to the failure of innovation in the use of coca leaves in consumer products. Indeed, some research denies any nutritional use of coca leaves (e.g., see Permy2009). Even the largest users of coca leaf in beverages, companies such as Coca Cola and PepsiCo, have failed to manufacture beverages using alkaloid-free extracts of coca leaf that are free of sweeteners. A Bolivian attempt to recreate the original cocaine-containing Coca Cola, Efilacoc's COCAREAL, is made using coca leaves and contains the traditional sugar. United Nations efforts to fight the cocaine trade, by convincing farmers who grow coca leaf to completely switch to growing cacao, teaches away from the use of coca leaf in foodstuffs such as those using cacao.

Another failure of others, since Alfred Niemann's observations in 1860, that one coca leaf alkaloid, benzoylmethylecgonine (the main alkaloid in coca leaves), “. . . produces temporary insensibility on the part of the tongue with which it comes in contact . . .”, or William Martindale's observation in his 1892 book, “Coca and Cocaine” (page 45), “The benumbing effect on the tongue . . . dulling its sensibility . . . I find is much greater on chewing a fresh living leaf than that produced by a member of dried leaves.”, has been the failure to apply these observations to problems of taste chemistry relevant to consumer food products. Indeed, this effect has been observed many times, but all of these observations failed to motivate development of consumer food products. Another failure of others since 1860 has been to determine which specific foods have bitterness diminished when coca alkaloids are present, nor have others since 1860 determined the minimum amounts of alkaloid needed for such desensitizing in commercial food products, nor have they determined how to cost effectively provide such amounts in commercial food products. These failures are much seen in the 1997 reference text for food chemists, “Modifying Bitterness: mechanism, ingredients and applications” (CRC Press: Glenn Roy, editor), which fails to consider in any form any use of coca leaf extracts. All these failures of despite decocainized coca leaves being generally recognized as safe (GRAS) under U.S. regulations (21 C.F.R. 182.20).

Previous use of coca extracts in products containing cocoa has been for cocoa products that by weight are at least 50% sugar and fat, for example, as seen in U.S. Pat. No. 4,883,181 (claim 9), or as seen in tourist treats in Cuzco, Peru, such as chocolate-covered coca leaves and truffles.

Clearly, it would be beneficial to have foodstuff's and methods that enable consumers to enjoy the health benefits of cocoa without enduring its bitter taste, if not as well for other bitter foods such as moringa. The present invention addresses these and other needs.

### BRIEF SUMMARY OF THE INVENTION

The present invention provides foodstuffs and methods that enable the consumption of cocoa without excessive bitterness, thereby enabling wider use of this important natural food in consumer food products, especially products with medical benefits.

In some embodiments, consumption of cocoa is made possible with products comprising unsweetened cocoa and extracts of coca leaf. In other embodiments, extracts of plants such as Valerian root and Hibiscus are used in place of, or combined with, extracts of coca leaf.

Accordingly, the present invention in one embodiment provides a cocoa-based foodstuff having reduced bitterness to taste, comprising i) C grams of unsweetened cocoa, ii) AL grams of at least one coca alkaloid, iii) F grams of fat and/or iv) S grams of sweeteners, wherein the sum of F and S is no more than about C, and wherein said at least one coca alkaloid is effective to reduce the bitterness of said unsweetened cocoa. In some embodiments, there is provided a cocoa-based foodstuff having reduced bitterness to taste, comprising i) C grams of unsweetened cocoa, ii) AL grams of at least one coca alkaloid, iii) F grams of fat and/or iv) S grams of sweeteners, wherein the sum of F and S is no more than about C, the ratio of AL to the sum of C, F, and S is no more than about 0.003, and said at least one coca alkaloid is effective to reduce the bitterness of said unsweetened cocoa.

The coca alkaloid(s) described herein can come from, for example, an extract of commercial coca-containing products (such as coca tea and coca flour), an extract of natural coca-containing plants or plant parts (such as coca leaves), or a chemically or biochemically synthesized, man-made chemical product. In some embodiments, the coca alkaloid(s) described herein may be derived from a natural source, for example, from coca leaves. In some exemplary embodiments, the coca alkaloid is derived from at least one member of the plant genus Erythroxylum. In some embodiments, the coca alkaloid is derived from at least one member selected from the group consisting of Erythroxylum coca, Erythroxylum novogranatense, and Erythroxylum brevipes.

In some embodiments, there is provided a cocoa-based foodstuff having reduced bitterness to taste, comprising i) C grams of unsweetened cocoa, ii) AL grams of an extract of coca leaves, iii) F grams of fat and/or iv) S grams of sweeteners, wherein the sum of F and S is no more than about C, and wherein said at least one coca alkaloid is effective to reduce the bitterness of said unsweetened cocoa. In some embodiments, there is provided a cocos-based foodstuff having reduced bitterness to taste, comprising i) C grams of unsweetened cocoa, ii) AL grams of coca leaves, iii) F grams of fat and/or iv) S grams of sweeteners, wherein the sum of F and S is no more than about C, the ratio of AL to the sum of C, F, and S is no more than about 0.003, and said at least one coca alkaloid is effective to reduce the bitterness of said unsweetened cocoa. In some embodiments, the extract of coca leaf contains at least one coca alkaloid being effective in reducing the bitterness of said unsweetened cocoa. In some embodiments, there is provided a cocoa-based foodstuff having reduced bitterness to taste, comprising i) C grams of unsweetened cocoa, ii) AL grams of an extract of coca leaves, iii) F grams of fat and/or iv) S grams of sweeteners, wherein the sum of F and S is no more than about C, wherein said extract of coca leaves is effective to reduce the bitterness of said unsweetened cocoa, wherein said coca leaves are from at least one member of the plant genus Erythroxylum, such as any of Erythroxylum coca, Erythroxylum novogranatense, and Erythroxylum brevipes.

The coca alkaloid described herein in some embodiments can be a known coca alkaloid commonly present in the extract of coca leaves, or an analog of such natural coca alkaloids that can similarly debitter cocoa-based foodstuff. For example, in some embodiments, said at least one coca alkaloid in the cocoa-based foodstuff described herein is selected from the group consisting of benzoylmethylecgonine, methyl ecgonine, methylecgonine cinnamate, benzoylecgonine, truxilline, hydroxytropacocaine, tropacocaine, ecgonine, cuscohygrine, dihydrocuscohygrine, nicotine, hygrine, and analogs thereof effective to reduce bitterness of cocoa, individually or in combination.

In some embodiments, the fat in the cocoa-based foodstuff described is selected from the group consisting of cacao butter, a milk fat, plant oil, an animal fat or a fat substitute.

In addition to the coca alkaloid(s), unsweetened cocoa, any fat or sweetener, the cocoa-based foodstuff described herein can further comprise ingredients such as flavor enhancing agent(s), supplement(s), protein(s), and liquid(s). In some embodiments, the cocoa-based foodstuff further comprises at least one flavor enhancing agent selected from the group consisting of: methyl benzoate, methyl cinnammate, and truxillic acid dimethyl ester. In some embodiments, the cocoa-based foodstuff having reduced bittemess to taste comprises i) C grams of unsweetened cocoa, ii) AL grams of at least one coca alkaloid (such as derived from an extract of coca leaves), iii) F grams of fat and/or iv) S grams of sweeteners, and v) SP grams of at least one supplement selected from the group consisting of phytosterols, L-theanine, n-acetylcysteine, 5′-ribonucleotides, taurine, mulberry, xanthohumol, hesperidins, glycomacropeptide, alpha lipoic acid, omega-3 fatty acids, omega-6 fatty acids, (soy) lecithin, gum Arabic, polysorbate 80, tocopherol, vanilla, vanillin, taurine, artificial flavors, probiotic cultures, green tea extracts, carrageenan, cinnamon, saw palmetto, rhodiola, red yeast rice, strawberries, and ginseng, wherein the sum of F and S is no more than about C, wherein said at least one coca alkaloid is effective to reduce the bitterness of said unsweetened cocoa, and wherein the ratio of AL to the sum of C, F, S, and SP is approximately equal to or less than the ratio of the maximum allowable amount of coca alkaloid that can be legally used in said foodstuff (such as about 0.001) (see Schedule III.4 of the U.N. Single Convention on Narcotics Drugs, 1961—hereinafter referred to as “UNSCND”). In some embodiments, the cocoa-based foodstuff further comprises at least one protein derived from a protein source selected from the group consisting of quinoa, amaranth, soy, powdered egg components, spirulina, whey and casein. In some embodiments, the cocoa-based foodstuff further comprises at least one liquid selected from the group consisting of water, green tea, black tea, coffee, animal milk, plant milk, and a fruit juice. In some embodiments, the cocoa-based foodstuff having reduced bitterness to taste comprises i) C grams of unsweetened cocoa, ii) AL grams of at least one coca alkaloid (such as derived from an extract of coca leaves), iii) F grams of fat and/or iv) S grams of sweeteners, and v) L grams of at least one liquid, wherein the sum of F and S is no more than about C, wherein said at least one coca alkaloid is effective to reduce the bitterness of said unsweetened cocoa, and wherein the ratio of AL to the sum of C, F, S, and L is approximately equal to or less than the ratio of the maximum allowable amount of coca alkaloid that can be legally used in said foodstuff (such as about 0.001).

The present invention further provides a cocoa-based foodstuff having reduced bitterness to taste, comprising i) C grams of unsweetened cocoa, ii) V grams of Valerian root, iii) F grams of fat and/or iv) S grams of sweeteners, wherein the sum of F and S is no more than about C. In some embodiments, there is provided a cocoa-based foodstuff having reduced bitterness to taste, comprising i) C grams of unsweetened cocoa, ii) V grams of Valerian root, iii) F grams of fat and/or iv) S grams of sweeteners, wherein the sum of F and S is no more than about C, and wherein the ratio of V to C is no less than about 0.04.

The present invention also provides a cocoa-based foodstuff having reduced bitterness to taste, comprising i) C grams of unsweetened cocoa, ii) H grams of Hibiscus extract, iii) F grams of fat and/or iv) S grams of sweeteners, wherein the sum of F and S is no more than about C. In some embodiments, there is provided a cocoa-based foodstuff having reduced bitterness to taste, comprising i) C grams of unsweetened cocoa, ii) H grams of Hibiscus extract, iii) F grams of fat and/or iv) S grams of sweeteners, wherein the sum of F and S is no more than about C, and wherein the ratio of H to C is no less than about 0.08.

In another aspect, there are provided methods of debittering cocoa-based foodstuff. For example, in some embodiments, there is provided a method of debittering cocoa-based food stuff, comprising adding AL grams of at least one coca alkaloid to a mixture comprising: i) C grams of unsweetened cocoa, ii) F grams of fat, and/or iii) S grams of sweeteners, wherein the weight ratio of F+S to C is no more than about 1; and wherein said at least one coca alkaloid is effective to reduce the bitterness of said unsweetened cocoa. In some embodiments, there is provided a method of debittering cocoa-based foodstuff comprising adding AL grams of an extract of coca leaf to a mixture comprising: i) C grams of unsweetened cocoa, ii) F grams of fat, and/or iii) S grams of sweeteners, wherein the weight ratio of F+S to C is no more than about 1; and wherein said extract of coca leaf is effective to reduce the bitterness of said unsweetened cocoa. In some embodiments, there is provided a method of debittering cocoa-based foodstuff comprising adding V grams of Valerian root to a mixture comprising: i) C grams of unsweetened cocoa, ii) F grams of fat, and/or iii) S grams of sweeteners, wherein the weight ratio of F+S to C is no more than about 1; and wherein said Valerian root is effective to reduce the bitterness of said unsweetened cocoa. In some embodiments, there is provided a method of debittering cocoa-based foodstuff comprising adding H grams of Hibiscus extract to a mixture comprising: i) C grams of unsweetened cocoa, ii) F grams of fat, and/or iii) S grams of sweeteners, wherein the weight ratio of F+S to C is no more than about 1; and wherein said Hibiscus extract is effective to reduce the bitterness of said unsweetened cocoa.

In another aspect, there are provided methods of improving taste of cocoa-based food stuff. In some embodiments, there is provided a method of improving the taste of cocoa-based foodstuff comprising adding AL grams of at least one coca alkaloid to a mixture comprising: i) C grams of unsweetened cocoa, ii) F grams of fat, and/or iii) S grams of sweeteners, wherein the weight ratio of F+S to C is no more than about 1; and wherein said at least one coca alkaloid is effective to reduce the bitterness of said unsweetened cocoa. In some embodiments, there is provided a method of improving the taste of cocoa-based foodstuff comprising adding AL grams of an extract of coca leaf to a mixture comprising i) C grams of unsweetened cocoa, ii) F grams of fat, and/or iii) S grams of sweeteners, wherein the weight ratio of F+S to C is no more than about 1; and wherein said extract of coca leaf is effective to reduce the bitterness of said unsweetened cocoa. In some embodiments, there is provided a method of improving the taste of cocoa-based foodstuff comprising adding V grams of Valerian root to a mixture comprising: i) C grams of unsweetened cocoa, ii) F grams of fat, and/or iii) S grams of sweeteners, wherein the weight ratio of F+S to C is no more than about 1; and wherein said Valerian root is effective to reduce the bitterness of said unsweetened cocoa. In some embodiments, there is provided a method of improving the taste of cocoa-based foodstuff comprising adding H grams of Hibiscus extract to a mixture comprising: i) C grams of unsweetened cocoa, ii) F grams of fat, and/or iii) S grams of sweeteners, wherein the weight ratio of F+S to C is no more than about 1; and wherein said Hibiscus extract is effective to reduce the bitterness of said unsweetened cocoa.

In another aspect, there are provided kits comprising unsweetened cocoa and debittering agents. For example, in some embodiments, there is provided a kit comprising: i) AL grams of at least one coca alkaloid, ii) C grams of unsweetened cocoa, iii) F grams of fat, and/or iv) S grams of sweeteners, wherein the weight ratio of F+S to C is no more than about 1; and wherein said at least one coca alkaloid is effective to reduce the bitterness of said unsweetened cocoa. In some embodiments, there is provided a kit comprising: i) AL grams of an extract of coca leaf, ii) C grams of unsweetened cocoa, iii) F grams of fat, and/or iv) S grams of sweeteners, wherein the weight ratio of F+S to C is no more than about 1; and wherein said extract of coca leaf is effective to reduce the bitterness of said unsweetened cocoa. In some embodiments, there is provided a kit comprising: i) V grams of Valerian root, ii) C grams of unsweetened cocoa, iii) F grams of fat, and/or iv) S grams of sweeteners, wherein the weight ratio of F+S to C is no more than about 1; and wherein said Valerian root is effective to reduce the bitterness of said unsweetened cocoa. In some embodiments, there is provided a kit comprising: i) H grams of Hibiscus extract, ii) C grams of unsweetened cocoa, iii) F grams of fat, and/or iv) S grams of sweeteners, wherein the weight ratio of F+S to C is no more than about 1; and wherein said Hibiscus extract is effective to reduce the bitterness of said unsweetened cocoa.

The descriptions herein about cocoa-based foodstuffs comprising at least one coca alkaloid (such as from an extract of coca leaf) apply equally to cocoa-based foodstuffs comprising Valerian root, or other herbs (such as Hibiscus) having similar effects as coca alkaloid(s), extracts of coca leaf or Valerian root in reducing bitterness of unsweetened cocoa. For example, in some embodiments, a cocoa-based foodstuff comprising Valerian root can further comprise any one of, or any combinations of the flavor enhancing agent(s), supplement(s), protein(s), and liquid(s) described herein for a cocoa-based foodstuff comprising at least one coca alkaloid. Typically, the amount by weight of Hibiscus extract added to a Hibiscus-containing cocoa-based foodstuff is twice as much as the amount of Valerian root added to a corresponding Valerian-root containing cocoa-based foodstuff to achieve similar debittering effect.

As used herein, the singular form “a”, “an”, and “the” includes plural references unless indicated otherwise.

Reference to “about” a value or parameter herein includes (and describes) embodiments that are directed to that value or parameter per se. For example, description referring to “about X” includes description of “X.”

The compositions and methods of the present invention may comprise, consist of, or consist essentially of the essential elements and limitations of the invention described herein, as well as any additional or optional ingredients, components, or limitations described herein or otherwise useful.

Unless otherwise noted, technical terms are used according to conventional usage.

### BRIEF DESCRIPTION OF THE DRAWINGS

FIG. 1 is a table of sugar and fat content of a variety of chocolates.

FIG. 2 is a brain scan of someone exposed to sugar (left), or cocaine (right).

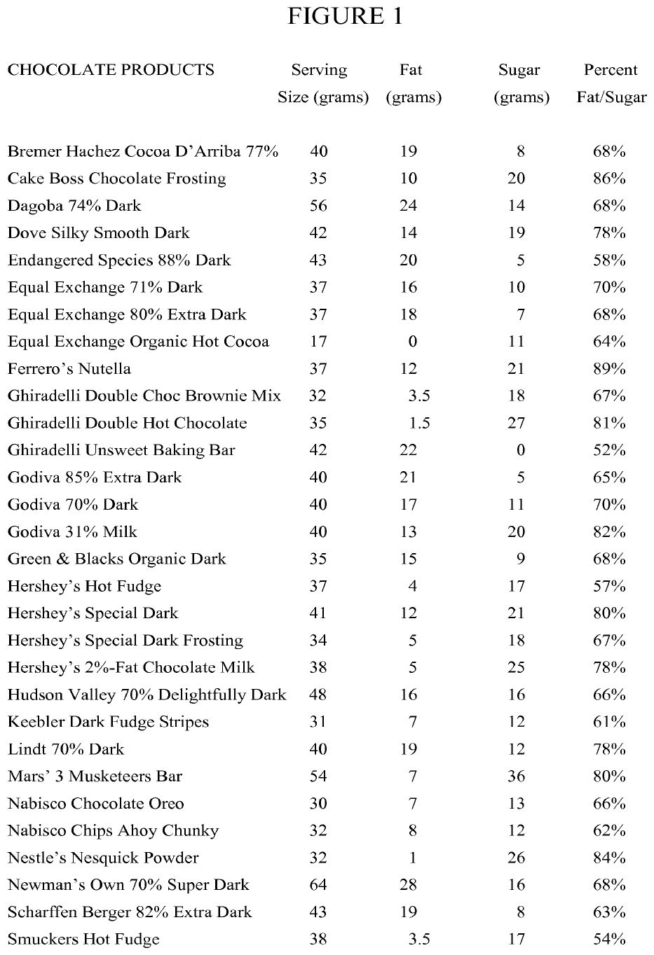

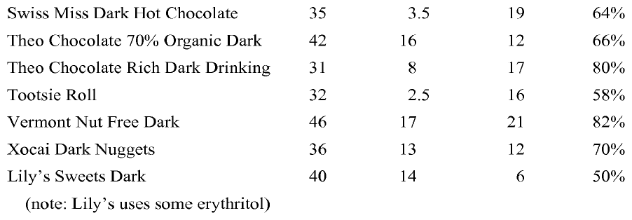

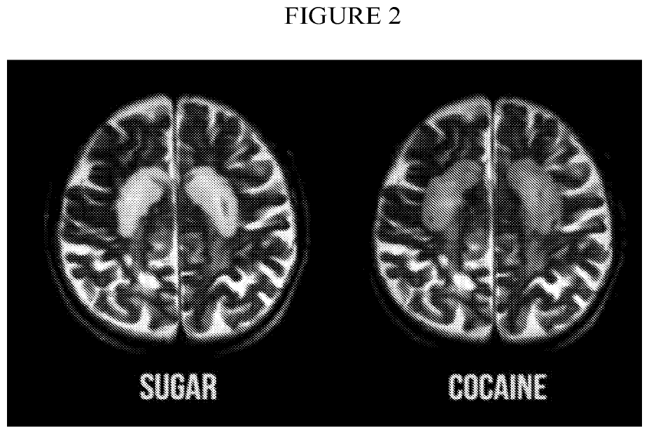

### DETAILED DESCRIPTION OF THE INVENTION

The present invention provides materials and methods for reducing the bitterness of some consumable plant products, such as cocoa. More specifically, the materials and methods provided by the invention enable the reduction of cocoa's bitterness without having to use sugars (and/or artificial sweeteners) and fats in amounts that can be substantially deleterious to human health. Still more specifically, the materials and methods disclosed herein enable the reduction of the bitterness of cocoa without using sugars (and/or artificial sweeteners) and fats in substantial amounts. Thus, those having ordinary skill in the art will understand from the present Disclosure that the present invention substantially removes some of the barriers to obtaining the significant health benefits of unsweetened cocoa.

### Glossary

The following terms are used herein as defined below unless specifically stated otherwise:

“Extract of Coca Leaf”. As used herein, the phrase “extract of coca leaf” (and its semantic equivalents) refers to one or more chemical constituents of the leaves of coca plants. Such chemicals can be obtained by extraction from coca leaves, e.g., by brewing coca leaves in water, or chemical extraction with solvents. Such chemicals can also be from synthetic sources, such as chemical synthesis or biological production, e.g., using recombinant genetic methods.

“Cocoa”. As used herein, the term “cacao” and “cocoa” (and their semantic equivalents) refer to cocoa that is obtained from the cacao tree (Theobroma cacao), and cocoa that is bioengineered and/or chemically engineered. There can be slight differences in the use of “cacao” and “cocoa”. For example, one difference between “cacao powder” and “cocoa powder”, in some cases, can be that “cacao powder” is unsweetened cocoa with some cacao butter, whereas “cocoa powder” is absent the butter. To the extent that both have bittemess, both are amenable to the debittering embodiments disclosed herein.

### Cocoa-Containing Foods and Beverages Containing Coca Extracts

The present invention provides materials, compositions and methods that provide food products that contain unsweetened cocoa that are less bitter, and therefore more palatable or less deleterious to a consumer's health, than the same food in the absence of the invention.

The nature of many of embodiments disclosed herein can be seen in an example. An exemplary method for preparing an extract of coca leaf is as follows. Brew two to four bags of coca tea (e.g. ECOCARANAVI® brand) in hot water (e.g. about 1 to 2 cups) for three to five minutes. Mix in two tablespoons of unsweetened cocoa powder (approximately 14 to 15 grams, though weight can vary according to the brank of powder). The resulting beverage has a reduced bitterness to taste to the extent that it is as enjoyably drinkable, for example, as drinking a cup of black coffee, as opposed to the unpleasant bitter taste when drinking just unsweetened cocoa in hot water. The number of bags of coca tea used is at the taste preference of the consumer, with those who like a “stronger” taste using fewer bags of tea.

In a first aspect, the present invention provides a cocoa-based foodstuff having reduced bitterness to taste. In one embodiment, the cocoa-based foodstuff of the invention comprises unsweetened cocoa and at least one coca alkaloid. The unsweetened cocoa and the total weight of the coca alkaloid(s) are combined in a coca alkaloid cocoa weight ratio that reduces substantially the bitterness of the foodstuff in the absence of the at least one coca alkaloid. In another embodiment, the weight ratio is approximately equal to or less than the coca alkaloid: cocoa weight ratio defined by the weight of the greatest legally permissible amount of the at least one coca alkaloid to the weight of the unsweetened cocoa (see UNSCND, Schedule III.4). In a more specific embodiment, the ratio is no more than about 0.001. In some embodiments, the weight ratio of the coca alkaloid(s) to cocoa is no more than about any of 0.00001, 0.0001, 0.0005, 0.001, 0.002, 0.003, 0.004, 0.005, 0.006, 0.007, 0.008, 0.009, 0.01, 0.02, 0.05, or 0.1. In some embodiments, the weight ratio the coca alkaloid(s) to cocoa is about 0.0001 to about 0.0005, about 0.0005 to about 0.001, about 0.0003 to about 0.0008, about 0.001 to about 0.002, about 0.002 to about 0.003, about 0.003 to about 0.004, about 0.004 to about 0.005, about 0.005 to about 0.006, about 0.006 to about 0.007, 0.007 to about 0.008, about 0.008 to about 0.009, about 0 009 to about 0.01, about 0.0005 to about 0.0015, about 0.0015 to about 0.0025, about 0.0025 to about 0.0035, about 0.0035 to about 0.0045, about 0.0045 to about 0,0055, about 0.0055 to about 0.0065, about 0,0065 to about 0.0075, about 0.0075 to about 0.0085, about 0.0085 to about 0.0095, about 0.0005 to about 0.0025, about 0.001 to about 0.005, about 0.002 to about 0.005, about 0.002 to about 0.007, about 0.001 to about 0.004, about 0.004 to about 0.008, about 0.005 to about 0.01, about 0.005 to about 0.015, about 0.01 to about 0.02, about 0.02 to about 0.05, or about 0.05 to about 0.1.

In another embodiment, the cocoa-based foodstuff of the invention comprises:
C grams of unsweetened cocoa,
AL grams of at least one coca alkaloid, said at least one coca alkaloid being effective to reduce the bitterness of said unsweetened cocoa;
F grams of fat and/or S grams of sweeteners;
wherein 0≲(F+S)≲C.

In some embodiments of a cocoa-based foodstuff comprising AL grams of at least one coca alkaloid, the ratio of F+S to C is no more than about any of 1:1, 1:2, 1:3, 1:4, 1:5, 1:6, 1:7, 1:8, 1:9, or 1:10. In some embodiments described by this formula, the weight ratio of F+S to C is no more than about 1:1, and the ratio AL/(C+F+S)≤0.003 (i.e. the ratio of AL to C+F+S is no more than about 0.003).

In another embodiment, the cocoa-based foodstuff of the invention comprises:
C grams of unsweetened cocoa;
AL grams of an extract of coca leaf containing at least one coca alkaloid being effective to reduce the bitterness of said unsweetened cocoa;
F grams of fat and/or S grams of sweeteners;
wherein 0≲(F+S)≲C.

In some embodiments of a cocoa-based foodstuff comprising C grams of an extract of coca leaf, the weight ratio of F+S to C is no more than about any of 1:1, 1:2, 1:3, 1:4, 1:5, 1:6, 1:7, 1:8, 1:9, or 1:10.

Sources of Cocoa. Any unsweetened cocoa can be used with the present invention. The following illustrative examples mostly use HERSHEY'S UNSWEETENED COCOA POWDER®, but satisfactory results can be obtained by using other commercial sources, such as, for example and not limitation, CADBURY'S BOURNVILLE COCOA®, MADISA'S CELINDA COCOA®, or any other unsweetened cocoa powder product or industrial supply for large-scale manufacturing of the products disclosed herein. Other cocoa powders include EL CEIBO® COCOA POWDER (Bolivia), GOURMET BITTER CHOCOLATE® (sold by Good Food S. A. in Chile), and MARCO POLO® and COPACABANA BITTER CHOCOLATES® (sold by ICB S. A. in Chile), as well as unsweetened cocoa powders available in the United States from Navitas, Rapunzel, Equal Exchange and Lake Champlain Chocolates. Some embodiments use unsweetened cocoa where the cocoa is not prepared using the Dutch process (i.e., wherein the cocoa is treated with an alkalizing agent to make it less bitter at the expense of reducing levels of flavonols). In 2014, Consumerist. com conducted a study of cocoas, and found varying concentrations of flavonols, and in some cases, a milligram or so of cadmium (which in high quantities when consumed can cause health problem). Cocoas such as Mar's CocoaVia, while expensive, were reported to be high in flavonols and very low in terms of cadmium. Less expensive equivalents of such cocoas can be used in some of the embodiments disclosed herein. Any of these cocoas can be supplemented with additional theobromine and/or flavonols when producing the products disclosed herein.

Varieties of Coca Leaf and Coca Tea. In some embodiments, the coca alkaloid is derived from a natural source. In some embodiments, the natural source is at least one member of the plant genus Erythroxylum, including but not limited to Erythroxylum recurrens, Erythroxylum steyermarkii, Erythroxylum brownianum, Erythroxylum monogymon, Erythroxylum rotundifolium, Erythroxylum impressum, Erythroxylum incrassatum, Erythroxylum gracilipes, Erythroxylum arcolatum, Erythroxylum panamense, Erythroxylum pelleterianum, Erythroxylum fimbriatum, Erythroxylum deciduum, Erythroxylum shatoni, Erythroxylum pulchrum, Erythroxylum glaucum, Erythroxylum lucidum, Erythroxyluml campestre, Erythroxylum amazonicum, Erythroxylum cataractarum, Erythroxylum cumanense, Erythroxylum mamacoca, Erythroxylum ulei, Erythroxylum coca (such as Erythroxylum coca var. coca and Erythroxylum coca var. ipadu), Erythroxylum novogranatense (such as Erythroxylum novogranatense var. novogranatense and Erythroxylum novogranatense var. truxillense), Erythroxylum sp., Erythroxylum brevipes. Certain plants from other families are also known to produce biologically active alkaloids (such as tropane alkaloids) with chemical structures closely related to the coca alkaloids, or with chemical properties related to those of the coca alkaloids. Therefore, in some embodiments, any of the leaves or parts of such plants, including but not limited to the members of the plant families Brassicaceae and Solanaceae, can also serve as the natural source for coca-like alkaloid(s) added to cocoa to achieve similar debittering effects. In more specific embodiments, the member is selected from the group consisting of Erythroxylum coca, Erythroxylum novogranatense and Erythroxylum brevipes. As will be appreciated by those having ordinary skill in the art, there are over 200 species of the Erythroxylum genus, the species of many of which contain coca alkaloids. Two main species, Erythroxylum coca and Erythroxylum novogranatense, are cultivated for the coca alkaloids in their leaves. Another species, Erythroxylum brevipes is also thought to contain coca alkaloid in its leaves, though most wild species that contain coca alkaloids have lower concentrations. The leaves of E. coca and E. novogranatense are used to make a variety of coca teas, many of which can be used to produce the products disclosed herein. One additional health benefit of extracts of coca leaf is that they are also an additional source of flavanols, to add to those provided by the cocoa.

Commercial sources are available for coca alkaloid. Some brands of mate de coca include HERBIR, DELISSER, and ANDES SPIRIT® (manufactured in Peru), and WINDSOR®, ECOCARANAVI®, JATANI®, and NOVOANDINA (manufactured in Bolivia). Coca leaves can be legally bought in small and large amounts in Bolivia (regulated by the industrialization unit, DIGCOIN, of the Vice Ministry for Coca and Integrated Development), used as is or ground up for some of the embodiments disclosed herein. Coca teas are readily available for sale in Peru and Bolivia, and available for sale in Chile, Colombia and (northern) Argentina. Circa 2015, NovoAndina International (www.novoandinastore.com) was selling a concentrated powdered extract of coca leaf, “Caranavi Extract: Full Alkaloids Coca”, and a liquid extract, “Liquid [Coca] Extract: Alcohol Free”. Either product can be used in the embodiments disclosed herein.

In some embodiments, the brewing times for coca tea bags can be between about 3 minutes to 5 minutes, for example, to use the brew to prepare for the extraction of one or more coca alkaloids. Brewing times for coca leaves can be about 10 minutes to 20 minutes. Brewing temperatures can range from 70° C. to 100° C., as with other teas, though some suggest that temperatures no more than 90° C. extract the most nutrients and flavor, which is easy to achieve at high altitudes such as in the Andes, where water boils at 89° C. So-called “cold-brewing” can be used as well, where tea is brewed for even longer periods of time in colder water, either fully immersed or by slow-drip brewing, using either coca tea or full coca leaves. Brewing temperature does not seem to affect reduction of bitterness, so that products that combine unsweetened cocoa, and coca, can be made for use at room temperature, or below, such as candy bars or beverages. To improve taste and safety, the coca leaves (e.g., full or milled) can first be washed in an alcohol such as ethanol (e.g., quickly rinsing 15 grams of coca tea leaves with 350 milliliters of a solution that is 96% ethanol and 4% water), After the rinse, the wet leaves are dried, which removes all of the alcohol. This rinse process removes surface contaminants, if any, as well part of the chemicals in leaves (e.g., chlorophyll), the tastes of which can interfere with the chocolate taste of the products disclosed herein. A multi-hour, slow-drip brewing of coca leaves or tea, with this ethanol solution, extracts a substantial amount of coca alkaloids.

As an alternative method of preparation, one can add a small amount, for example, an ⅛^{th} of a tablespoon of liquid coca leaf extract to the hot water, or an equivalent amount of coca leaf flour, as long as the liquid extract or powder similarly decreases bitterness. One manufacturer of a liquid extract of coca leaves is the International Coca Research Institute, in La Paz, Bolivia.

Coca Alkaloids. Leaves of some species of Erythroxylum (for example, E. Coca) contain a variety of sensory and/or aromatic alkaloids which can be used in the products disclosed herein, including, but not limited to coca alkaloids selected from the group comprising: benzoylmethylecgonine, ecgonine, methyl ecgonine (also referred to as ecgonine methyl ester) methylecgonine cinnamate (cinnamoylcocaine), benzoylecgonine (mostly a metabolite), truxillines (cocamine is alpha-truxilline), tropacocaine, hydroxytropacocaine, hygrine (which has a slight burning taste), cuscohygrine, dihydrocuscohygrine, and nicotine, as well as their analogs. The first three alkaloids tend to dominate, in a ratio which can be 9:3:2 or 8:2:2. Such alkaloids (and other chemicals, for example, flavorings, vitamins, minerals, etc.) can be extracted from the coca leaves, can be chemically synthesized, can be obtained from leaves from other plants (or similarly acting alkaloids can be obtained from other plants), or can be synthesized by modified organisms such as algae (see Leo2009, incorporated herein by reference), before being added to the products disclosed herein. In some embodiments, the coca alkaloid(s) is non-addictive. Some of these alkaloids can also be found in species of the Datura plant. For example, the main alkaloid, benzoylmethylecgonine, can be obtained from industrial suppliers, such as Hallmark Industrious Pharma of Malaysia.

Quantitation of Alkaloids in Coca Tea. A 1996 NIH study [see Jenkins 1996] measured the coca alkaloids released from coca leaves when brewing tea, analyzing coca leaves from both Peru and Bolivia. After three minutes of brewing at 94° C., an average of approximately 4 milligrams to 5 milligrams of benzoylmethylecgonine was released, increasing to 5 millgrams to 6 milligrams if brewed to up to 15 minutes. A typical brew of a typical coca tea will typically release 5 milligrams of benzoylmethylecgonine. Similarly the study found an average of approximately 1.5 milligrams to 2.5 milligrams of ecgonine methyl ester released, an average of approximately 0.1 milligrams to 0.9 milligrams of benzoylecgonine, and an average of approximately 0.1 milligrams of trans-cinnamoylcocaine. Smaller amounts of other alkaloids were reported in this study, and have been reported in other studies.

Coca Flavorings. Some embodiments include at least one flavor enhancing agent. One family of chemicals derived from coca leaves, typically as breakdown products when consumed, are methyl benzoate, methyl cinnamate and the dimethyl ester of truxillic acid (see, e.g., U.S. Pat. No. 4,260,517, incorporated herein by reference). One or more of these, and other coca aroma chemicals, can be obtained from an extract of coca leaves (for example, using the methods of U.S. Pat. No. 4,956,429, “Method of making a coca leaf flavor extract”, incorporated herein by reference), and/or can be obtained synthetically, for use in some of the products disclosed herein. Coca leaves from the Yungas region of Bolivia, preferred there for teas and chewing, tend to have more of these flavorings in their extracts, while coca leaves from the Chapare region of Bolivia tend to have less. Embodiments of the products disclosed herein can have more of a chocolate taste by using the coca leaves from the Chapare region, while other products disclosed herein can have more of a chocolate and coca taste by using the coca leaves from the Yungas region.

Chocolate Flavor Enhancement. In any instances where there is any diminishment of chocolate flavor in the embodiments disclosed herein, such diminishment can be somewhat compensated for by using chocolate flavorings or flavor enhancers, such as using one or more 5′-ribonucleotides as an odor and flavor enhancer for chocolate (as noted in the 1998 book, “Flavourings: production, composition, applications and regulations”, page 311; or as disclosed in PCT publication WO2009013240, “Chocolate flavor enhancer: ribonucleotides”). Another chocolate flavor enhancer is tetra-methyl pyrazine (in particular, 2,3,5,6-tetramethylpyrazine), as disclosed in U.S. Pat. No. 3,459,556 (in turn, cited by U.S. Pat. No. 4,707,365), both incorporated herein by reference.

Use of Synthetic Analogs of Coca Alkaloid. In another embodiment, chemical analogs of coca alkaloids, with similar short-acting, taste-altering effects, are mixed with the cocoa foodstuff of the invention. A list of many such analogs is available at: http://en.wikipedia.org/wiki/List_of_cocaine_analogues, incorporated herein by reference in its entirety and for all purposes. Examples of coca alkaloid analogs include but are not limited to stereoisomers, 3β-phenyl ring substituted analogs, 2β-substituted analogs, N-modified analogs, 3β-carbamoyl analogs, or piperidine homologs of methylecgonine, or 3β-alkyl-3-benzyl tropanes, 6/7-substituted methylecgonine, or 6-alkyl-3-benzyl tropanes. Many variants of methylbenzoylecgonine have been created by varying the methyl and benzoyl radicals, for example, by substituting other alkyl radicals for the methyl radical, or, for example, by substituting other aromatic acid radicals for the benzoyl radical. In some exemplary embodiments, the coca alkaloid analog comprises amylocaine, articaine, benzocaine, bupivacaine, butacaine, carticaine, chloroprocaine, cinchocaine, cyclomethycaine, etidocaine, hexylcaine, levobupivacaine, lidocaine, mepivacaine, meprylcaine, metabutoxycaine, norcocaine, piperocaine, prilocaine, propoxycaine, procaine, proparacaine, risocaine, ropivacaine, tetracaine, dimethocaine, or trimecaine. Any such synthetic versions of coca alkaloids, with similar taste-altering effects, can be used in the products disclosed herein, either solely or in combination with other chemicals found in the extracts of coca leaf. One family of such synthetic versions, designed to be non-addictive, is disclosed in U.S. Pat. No. 8,557,842, “Cocaine analogs and methods of preparation and uses thereof”, which is enclosed herein by reference, and which teaches modifications of the C-1, C-2, C-3, C-4 and N-8 positions of the tropane bicyclic scaffold of methylbenzoylecgonine. Another family of cocaine analogs is disclosed in U.S. Pat. No. 6,472,422, which is enclosed herein by reference. Methylecgonine, or its precursor, carbomethoxytropinone, can be starting points for synthetic coca alkaloids that are preferably short-acting, non-addictive, non-water-soluble, and non-regulated, while making unsweetened cocoa less bitter. Other chemical pathways for reaching methylecgonine and related chemicals, can also be starting points for synthesis of these derivatives, for example, using C-H functionalization techniques. An example of such chemical pathways is U.S. Pat. Application 20040171635, “Novel tropane esters and methods for producing and using them”, incorporated herein by reference. And much like coca alkaloids, any derivative used preferably should be non-sedative.

In one experiment, one tablespoon of unsweetened cocoa was mixed with one cup of hot water, with the result being the usual bitter hot cocoa drink. To this mixture was added one half (0.5) of a milliliter of CVS-brand Instant Mouth Pain Liquid, 20 percent of which is benzocaine. The resulting taste, while mostly not bitter (and a bit minty, due to inactive ingredients that are added), also mostly eliminated the taste of chocolate. Benzocaine, in the form of white powder, is often used to dilute cocaine sold at the street level, since it does not alter the taste of the cocaine, and thus can serve as a substitute for some of the alkaloids in extracts of coca leaf, to be mixed with unsweetened cocoa. Benzocaine, (or other coca alkaloid analogs with names ending in *-caines, such as lidocaine, procaine, prilocaine, tetracaine and primocaine), can have long duration times, which can interfere with the taste of foods or drinks consumed around the same time as food products with unsweetened cocoa. However, a new member of this benzoic acid family could be safely consumed, while making cocoa have less of a bitter taste without removing the cocoa taste, and while having short duration times. A lengthy list of cocaine analogs is available at: http://en.wikipedia.org/wiki/List of cocaine analogues. for use as is in the embodiments disclosed herein, or their derivatives and analogs so used.

### Use of Other Herbs

Certain plants from other families are also known to produce biologically active alkaloids (such as tropane alkaloids) with chemical structures related to the coca alkaloids, or with chemical properties related to those of the coca alkaloids. For example, other herbs (and some fruits) can be effective short-acting, de-bittering agents, for example, for use in mixtures with unsweetened cocoa. One such herb is valerian root. While valerian root can appreciably reduce the bitter smell and bitter taste of cocoa (for example, in hot water, mixing two tablespoons of cocoa with 900 or 1350 milligrams of valerian root powder, while using 450 milligrams of valerian root powder minimally reduces the bitterness of cocoa; a similar effect is achieved a few bags of valerian tea), it also can significantly reduce the “chocolate” taste of cocoa, which can reduce the commercial appeal of the mixture for its “chocolate” taste. However, another embodiment of the products disclosed herein comprises cocoa and valerian root, and optionally flavorings such as one or more fruit flavorings such as cherry or strawberry, or chocolate flavoring, and optionally extract of coca leaf, for example, as a nighttime beverage before sleep (in significant quantities, valerian root acts as a sedative). Similarly, approximately 2.7 grams of Nature's Bounty Green Tea Extract achieves a similar effect when added to cocoa as does adding half as much Valerian root to cocoa (the Extract contains some sweetener, glycerin, a sugar alcohol). Similarly, approximately 2 grams of, for example, Gaia Herb's Hibiscus Flower Extract achieves a similar effect when added to cocoa. Similarly, approximately 2 teaspoons of juice from a persimmon achieves a similar effect when added to cocoa, as does adding approximately 1 gram of grapeseed extract. Also, brewing six bags of, for example Herbi's Una de Gato tea (Uncaria tomentosa) and mixing in unsweetened cocoa, achieves a similar effect of diminishment of bitterness and ‘chocolate’ taste, as does one to three bags of pericon tea (Tagetes lucida). Similarly, approximately 400 milligrams of powdered saffron eliminates some bitterness while eliminated much of the “chocolate” taste, while being one of the most expensive herbs; with similar effects seen using approximately 900 and 1800 milligrams of cinnamon. Other examples of herbs (or extracts of the herbs thereof) that can achieve similar debittering effects when added to cocoa include but are not limited to clove (Eugenia caryophyllata), nutmeg (or mace, Myristica fragrans), bay leaves (such as Laurus nobilis), chamomile, calendula, Echinacea, anise (Pimpinella anisum), noni (Morinda citrifolia), wintergreen (Gaultheria procumbens), ginger (Zingiber officinale), turmeric (Curcuma longa), lavender (Lavandula), and peppermint (Mentha x piperita). Additional embodiments of the products disclosed herein comprise one of more of these herbs or fruits (in quantities similar to the above in this paragraph) with unsweetened cocoa, and optionally flavorings such as one or more fruit flavorings, and optionally extract of coca leaf. Additional embodiments of the products disclosed herein comprise one of more of these herbs or fruits (e.g. in quantities lesser than the above in this paragraph) with unsweetened cocoa and coca extract. In contrast, extracts and supplements such as elderberry liquid, nettle leaf, astragalus supreme, Chinese skullcap, sambucus (black elder berry extract), and St. John's wort, in amounts similar to those described herein for coca leaf or Valerian roots, provide little to no debittering when added to unsweetened cocoa. For extracts of all such herbs and fruits, such extracts need not include inessential elements such as vitamins, minerals and other non-taste affecting compounds. Such extracts can also be filtered to remove inessential particulate matter. In another embodiment, chemical analogs of the active ingredients of these plants, with similar taste-altering effects, are mixed with the cocoa foodstuff of the invention, especially analogs that retain more of the smell and taste of cocoa.

Thus, in some embodiments, the foodstuff provided by the invention comprises:
C grams of unsweetened cocoa;
V grams of Valerian root;
F grams of fat and/or S grams of sweeteners;
wherein 0≲(F+S)≲C.

In some embodiments of the foodstuff comprising Valerian root, the ratio of F+S to C is no more than about any of 1:1, 1:2, 1:3, 1:4, 1:5, 1:6, 1:7, 1:8, 1:9, or 1:10. In more specific embodiments described by this formula wherein the ratio of F+S to C is no more than about 1:1, the ratio of V to C is no less than about 0.04. In some embodiments, the ratio of V to C by is no less than about any of 0.005, 0.01, 0.02, 0.03, 0.04, 0.05, 0.06, 0.07, 0.08, 0.09, 0.1, 0.2, or 0.3. In some embodiments, the ratio of V to C is about 0.01 to about 0.05, about 0.04 to about 0.06, about 0.06 to about 0.08, about 0.02 to about 0.08, about 0.05 to about 0.1, about 0.04 to about 0.1, about 0.04 to about 0.15, about 0,04 to about 0.2, about 0.1 to about 0.2, about 0.2 to about 0.3, about 0.04 to about 0.3.

Bioactive ingredients in the Valerian root that might account for the cocoa-debittering effect include but are not limited to alkaloids (such as valerine, valerianine, shyanthine, chatinine, actinidine), sesquiterpenes (such as valerenic acid), and isovaleric acid. Therefore, in some embodiments, an extract of the Valerian root, or individual or any combination of the bioactive ingredients of the Valerian root, including those from commercial sources, derived from the Valerian root, synthesized chemically, or produced using biologically engineered organisms, can be added to cocoa to achieve the debittering effect. It is to be understood that descriptions herein about Valerian root apply equally to compositions containing other debittering herbs and fruits described herein.

Alternatively, Hibiscus extract can substitute for Valerian root in all cocoa-containing foodstuffs having reduced bitterness to taste. Typically, the amount by weight of Hibiscus extract added to a Hibiscus-containing cocoa-based foodstuff is twice as much as the amount of Valerian root added to a corresponding Valerian-root containing cocoa-based foodstuff to achieve similar debittering effect, while retaining more of the chocolate taste than Valerian root.

Accordingly, in some embodiments, the foodstuff provided by the invention comprises;
C Grams of Unsweetened Cocoa;
H grams of Hibiscus extract;
F grams of fat and/or S grams of sweeteners;
wherein 0≲(F+S)≲C.

In some embodiments of the foodstuff comprising Hibiscus extract, the ratio of F+S to C is no more than about any of 1:1, 1:2, 1:3, 1:4, 1:5, 1:6, 1:7, 1:8, 1:9, or 1:10. In more specific embodiments described by this formula wherein the ratio of F+S to C is no more than about 1:1, the ratio of H to C is no less than about 0.08. In some embodiments, the ratio of H to C by is no less than about any of 0.005, 0.01, 0.02, 0.03, 0.04, 0.05, 0.06, 0.07, 0.08, 0.09, 0.1, 0.12, 0.14, 0.16, 0.2, 0.3, or 0.4. In some embodiments, the ratio of H to C is about 0.02 to about 0.10, about 0.02 to about 0.04, about 0.04 to about 0.06, about 0.06 to about 0.08, about 0.08 to about 0.1, about 0.04 to about 0.1, about 0,05 to about 0.12, about 0.06 to about 0.1, about 0.06 to about 0.15, about 0.06 to about 0.2, about 0.1 to about 0.2, about 0.2 to about 0.3, about 0.04 to about 0.3.

### Taste, Aroma, Appearance, and Texture

Four key factors in food products are taste, aroma, appearance and texture. The use of chemical extracts of coca leaf to make cocoa less bitter retains much of the taste, aroma and appearance of “chocolate”. Discussed below are additives that can be added to the products disclosed herein to provide these four key factors to satisfy a variety of consumer preferences.

Another embodiment of the present invention includes a combination of cocoa, extract of coca leaf and quinoa powder, to provide some texture. Quinoa has many nutrients, including protein, while having little fat, no cholesterol, and no sugar (which is also mostly true for unsweetened cocoa powder, which has a bit of fat), but instead it has starches. Any other plant-derived protein that is low in sugar can be used with, or as a substitute for, quinoa powder, preferably proteins derived from plants that are free of gluten. Quinoa is one of the few plants that provide all essential amino acids, though in small amounts.

In another embodiment, milk powder is added to cocoa and powdered coca tea extract, the mixture of which is added to hot water. In another embodiment, milk is heated (to about 100 ° C., but brewing temperatures can range from about 70° C. to about 100° C., as with other teas), to which the cocoa and coca tea leaf extract can be added. One milk product that can be used with the products disclosed herein is Fairlife milk, a cold filtered milk with half of the sugar and 50% more protein than regular milk. In more specific embodiments, protein sources that do not bind to flavonols are used for the products disclosed herein. Another protein source can be collagen hydrolyzates, such as VITAGEL® collagen from Biogel AG (Switzerland). The milk source typically will be cow milk, but milk from another animal (for example, from a buffalo, goat, sheep and/or llama) can be used, or from a plant-derived milk-like beverage (for example, plants such as quinoa, almonds, coconuts, soy, rice, flax, and/or hemp). For those embodiments that make use of protein sources with fats, an emulsifier and surfactant such as lecithin (which has been used in some pharmaceuticals to modulate bitterness, and which have phospholipids as one component, and is also a source of an essential nutrient, choline), gum Arabic, sodium phosphate, or polysorbate 60 can be added. Such emulsifiers include: lecithin derived from soya bean, safflower, com etc., fractionated lecithins enriched with either phosphatidyl choline, phosphatidyl ethanolamine, phosphatidyl inositol; emulsifiers derived from oats, mono- and diglycerides and their tartaric esters, monosodium phosphate derivatives of mono- and diglycerides of edible fats and oils, sorbitan monostearate, polyoxyethylene sorbitan monostearate, hydroxylated lecithin, synthetic phospholipids such as ammonium phosphatides, polyglycerol polyricinoleate (PGPR), lactylated fatty acid esters of glycerol and propylene glycol, polyglycerol esters of fatty acids, citric acid esters of fatty acids, propylene glycol mono- and diesters of fats and fatty acids.

Some embodiments of the foodstuff provided by the invention further comprise P grams of at least one protein; wherein the ratio AL/(C+F+S+P) is approximately equal to or less than the ratio of the maximum allowable amount of coca alkaloid that can be legally used in foodstuff with a medicinal use.

As will be appreciated by those having ordinary skill in the art, the use of an added protein source in the embodiments just mentioned, such as, but not limited to, quinoa, amaranth, soy, alpiste (canary grass), powdered egg whites, spirulina, or whey and casein-the protein components of milk, allows the addition of more coca leaf extract while staying under U.N. regulations on the amount of such extract in a medicine. For example, one embodiment disclosed herein combines one tablespoon of cocoa with the coca leaf extract equivalent to brewing two bags of tea in hot water. However, in some cases, this leads to double the amount of coca alkaloid as allowed by international law (see UNSCND, Schedule III.4). However, adding in one tablespoon of a protein source such as quinoa brings the ratio of cocoa/protein to coca alkaloid below international limits. For example, for some embodiments of the products disclosed herein, for every C grams of cocoa and P grams of protein and AL grams of alkaloid, that AL/(C+P)≲0.001.

Coca Extracts and Protein versus Artificial Sweeteners. One problem with most artificial sweeteners, beyond their bitter taste, is that their sweetness falsely signals the body that calories are being consumed, when they are not. This can lead to the body seeking calories elsewhere, so that in some cases, use of artificially sweetened foods and beverages, counterintuitively, can lead to weight gain despite the absence of sugar and its calories. Adding protein to combinations of coca tea extract and cocoa, in addition to the nutrition value of protein, also does not falsely signal the body with regards to calories. Protein is a source of calories without sugar, and better, more calories are required to process proteins than sugars (carbohydrates) and fats. Additionally, protein reduces appetite, per calorie, more than sugars (carbohydrates) and fats.

A Bit of Sweet. Some embodiments of the invention can include sugar, but such use is optional. While cocoa and coca leaf extract, and any other ingredients, can be combined and consumed without sugar, some sugar can be added as a sweetener without subtracting much in the way of health benefits. While a typical canned (or bottled) beverage contains over 40 grams of sugar, the products disclosed herein can have added a small amount of sugar, for example, approximately 1 teaspoon of sugar, which weighs 4.2 grams (corresponding to 15 calories), which is a small fraction of the 40 grams to 60 grams of sugar in a typical can of soda or juice. This amount of natural sweetener can also be provided by approximately one teaspoon of, for example, agave, jaggery, honey, molasses, and/or syrup; or from about a half of cup of skimmed milk (or its equivalent in powdered form of one tablespoon of whole or skim milk powder).

Lucuma, a subtropical fruit from Peru, in liquid or powder form, can be used as a low-glycemic sweetener. A new natural sweetener can be used, tagatose, which is 92% as sweet as sugar, but only has one third of the calories of sugar. Tagatose, for example, can replace sugar 1:1 in terms of weight (slightly less sweetness), or 1:1 in terms of calories (about three times as sweet). Many other medicines make use of sugar, typically a few grams per 5 milliliters, a greater use of sugar than adding a few grams of sugar to 15 milliliters to 30 milliliters (1 to 2 tablespoons) to the cocoa-based medicines disclosed herein. To the same extent, inulin can be added to the products disclosed herein. Inulin can be a slightly sweet replacement for sugar, fat and flour in food products, as well as being a soluble fiber, though in large quantities can lead to gas and bloating. A variety of starches (polysaccharides) such as cornstarch or tapioca, as well as starch sugars such as maltodextrin, can be used to add both some sweetness and/or some thickness. A fruit from Brazil, cupuaçu, can also be used as a natural sweetener in some of the embodiments disclosed herein. Cupuaçu has a fair amount of sugar, some fat, and for many people has a taste with elements of chocolate, along with the tastes of bananas, pear, passion fruit and pineapple. A fruit from Bolivia and Peru, yacon, can be the basis for a fruity syrup in some of the embodiments disclosed herein that is also high-fiber

Sugar From Gelatin or Agar Agar. In some embodiment, gelatin can be added to the products disclosed herein. Gelatin, a mixture of peptides and proteins produced by partial hydrolysis of collagen, is about 13% sugar by weight. Thus it can be a source of protein and sugar for the products disclosed herein. For people who avoid food products derived from meat, such as gelatin, agar agar (or agar), derived from seaweed or algae, can be used. In Asian countries, agar is a popular ingredient in a variety of candies and deserts. Agar is known for use as a food thickener, a source of fiber, a fat substitute, and because it absorbs water in the stomach, it creates a feeling of being fuller with less food.

Artificial Sweetener—Alitame. In some embodiments, alitame is added to the foodstuffs of the invention. Alitame is an artificial sweetener similar to aspartame, with two important properties—it has no bitter aftertaste and it has no phenylalanine (for which a number of health related issues have been raised). Alitame can be added to the products disclosed herein. Any other artificial sweetener can be used as well, for example, SWEETWELL®

Sweet Proteins. Other embodiments of the invention include proteins that are naturally sweet (including monelin, thaumatin, pentadin, mabinlin, brazzein, and curculin). For example, monelin is derived from the West African shrub known as the serendipity berry, though its use in food products is limited as it is expensive to grow and extract. Thaumatin is derived from the West African katemfe fruit. Sclareolide, an herbal extract (e.g., from the clary sage plant), which has been used to reduce somewhat the bitterness of coffee (e.g., U.S. Pat. No. 4,988,532) can also be added to products disclosed herein, which use can also increase richness and creaminess sensations. Miraculin, derived from the Sunsepalum dulcificum plant, can also be added to the products disclosed herein.

More Than a Bit of Sugar. In other embodiments, the cocoa products of the invention comprise cocoa and coca leaf extract as described herein, but further include more sugar at the expense of decreasing the medical benefits of cocoa consumption. Typically, chocolate products such as candy have 3 times to 5 times as much sugar and fat as cocoa. For example, a Hershey Milk Chocolate bar weighing 43 grams has 13 grams of fat and 24 grams of sugar (37 grams in total), leaving at most 6 grams of cocoa, a ratio of 4:1. A packet of Swiss Miss Hot Chocolate weighing 26 grams, has 2 grams of fat and 19 grams of sugar (21 grams in total), leaving at most 5 grams of cocoa, again about a ratio of 4:1. Such products are essentially chocolate-flavored sugar and fat. Some more specific embodiments of products disclosed herein can easily use such ratios include ratios of sugar to cocoa on the order of 1:1 without loss of much in the way of pleasurable taste.

Added Fat. In other embodiments, the foodstuffs of the invention include cacao butter, its equivalent, or a combination thereof. Such additional fat is optional. The principle fat in many chocolates is cacao butter. Cacao butter can be added to the products disclosed herein. The main fat of cacao butter, stearic acid, a co-emulsifier and thickener, can also be obtained from industrial sources. Additionally, other fats can be added to the products disclosed herein. The chocolate industry denotes two types of alternative fats—Cocoa butter Equivalents (CBE) such as palm oil (with more CBEs specified in EU Directive 2000/36/EC), and Cocoa Butter Substitutes (CBS) of two types: lauric-based fats from oils of palm kernel or coconut, or non-lauric-based fats from oils of soy, cottonseed, peanut, rapeseed or corn. Suitable CBE's include illipe, Borneo tallow, tengkawang, palm oil, sal, shea, kokum gurgi and mango kernel, and are usually used in combination with cacao butter. Additionally, artificial fats (also known as fat substitutes) can be added to the products disclosed herein, such as maltodextrin, pectin, sucrose polyesters, and altered triglycerides. Additionally, hydrogenated ethoxylated glycerol esters can be added to the products disclosed herein, which can create a mouth feel of fat, while providing some bitterness reduction. Additionally, animal fats can be used, such as fish oil and butter. In some embodiments, where fat is added to products disclosed herein, dioctyl sodium sulfosuccinate can be added as a stabilizer. Recent reports that the resin from Protium heptaphyllum prevents high-fat diet-induced obesity when added to food and beverages given to mice, and occasional historical uses of resin from Protium heptaphyllum while chewing coca leaves, indicates that resin from Protium heptaphyllum can be added to some of the products disclosed herein with added fat to reduce the physiological impact of the added fat.

Added Fats and Sweeteners. The amounts of fat and sugar that can be added to the products disclosed herein can be chosen to meet the marketing needs of those producing some of the products disclosed herein. Less sugar and fat is needed than regular chocolate products, due to the de-bittering effects of extracts of coca leaves. One constraint for some of the products disclosed herein is that for every C grams of unsweetened cocoa and F grams of fat and S grams of sweeteners, that 0≲(F+S)≲C.

Cocoa, Coca and Inulin/Agavin. One chemical that has had some commercial success when combined with cocoa is inulin. Inulins are a group of naturally occurring polysaccharides produced by many plants such as chicory (chicory itself has some de-bittering properties, for example, when used with coffee). While inulins comprise many fructose polymers, they have a bond structure that makes them mostly not digestible, while contributing some sweetness and fewer calories, and while adding dietary fiber. Some surfactants can be based on inulin. One study reports that higher degree of polymerization (DP) inulin can be used with artificial sweeteners that produce much of the important sensory effects (appearance, firmness, smoothness, mouth feel, flavor and taste). Colorless and odorless, when it is mixed with liquid, it forms a gel and white creamy structure, similar to fat. It also can provide some health benefits, such as increasing calcium absorption and growth of beneficial intestinal bacteria. However, consumption of large quantities can lead to some gastrointestinal distress. Inulin can be added to some of products disclosed herein. Also that can be added to some of the products disclosed herein is agavin, a polymer of fructose molecules derived from the agave plant (used to make tequila), which also provides some sweetness, fiber, and is not readily absorbed by the body Recent reports suggest that agavin can help trigger insulin production and lower blood sugar levels (at least in mice). As an example of commercially available inulin powder, that can be used with the embodiments disclosed herein, is Organic Agave Inulin Powder sold by Z Natural Foods (West Palm Beach, Florida).

A Bit of Other Flavor Enhancers. While salt consumption has been linked to problems with high blood pressure, in moderation (under approximately 3 grams of sodium per day in a diet), salt is an excellent food seasoning. A bit of salt (especially low-sodium salt that includes potassium chloride) for example, 1/16th of a teaspoon (approximately 150 milligrams of sodium), can be added to combinations of cocoa and coca leaf extract. Salt and/or vanilla are typically added to chocolate products.

In some embodiments, the foodstuff provided by the invention further comprise L grams of at least one liquid; wherein the ratio AL/(C+F+S+L) is approximately equal to or less than the ratio of the maximum allowable amount of coca alkaloid that can be legally used in said foodstuff, where AL, F and S have the definitions given above. In more specific embodiments, the at least one liquid is selected from the group consisting of: water, green tea, black tea, coffee, animal milk, plant milk, and a fruit juice.

### Related Products

Still other embodiments of the invention include sugar-free combinations of cocoa and coca leaf that are made into food products such as candy bars or pudding. These additional ingredients can include soy, and any flour (horina) such as corn flour or wheat flour—any source of protein that is mostly free of far, sugar and/or cholesterol.

Coca Tea Extracts and Sodas. A variety of plant extracts, for example, the lemon flavoring obtained from lemon verbena (also known as Hierba luisa), are, or can be, the basis of soda drinks. Much like sugar-free beverages can be prepared using cocoa and coca tea extract, thus, in some embodiments coca tea extract is combined with such natural plant extracts in soda form that is without sugar or artificial sweeteners, for example, plants such as passion fruit or cranberry, as opposed to the current practice of preparing such sodas with sugar or artificial sweeteners.

Other Bitter Foods. There are other bitter foods, beyond cocoa, that have many nutritional benefits that can be made more consumable by decreasing their bitterness using the products and methods disclosed herein. One such food is the leaves of the moringa tree, a tree that is native to the Indian subcontinent. Gram for gram, moringa leaves can have 25 times the iron of spinach, 17 times the calcium of milk, 15 times the potassium of bananas, 10 times the vitamin A of carrots, and 9 times the protein of yogurt.

Coca and Marijuana Tea. With the growing legalization and popularity, has arisen the growing interest in the medical benefits of marijuana, in particular benefits from the cannabinoid chemicals available from the plant, the most popular of which is (−)-delta-9-tetrahydrocannabinol (“THC”), which is responsible for the psychoactive effects of the plant. However, there are dozens of other cannabinoids available from the plant, and one way to obtain the benefits of such cannabinoids without absorbing much THC, is the same way to obtain the benefits from the coca plant without absorbing much coca alkaloid drink tea as provided by the present invention. While there are a growing number of recipes for marijuana tea available on the Internet, many suffer from the same problems as does unsweetened cocoa, the use of sugar (e.g., honey) and/or far (e.g., butter) to mask some bitterness, though in the case of marijuana tea, the side-effect is more of a slight stinging sensation. Such marijuana tea can be made more pleasant by brewing in conjunction with coca tea. While coca tea typically takes 3 to 6 minutes for a good brew, marijuana tea takes longer, for example, 12 to 24 minutes. One exemplary brewing method is to put two bags of coca tea, and approximately one to two grams of marijuana, into a cup, add hot water, and allow to brew to taste for the marijuana.

Coca, Jambu and Hierba Luisa. Herba luisa is a flowering plant, the leaves of which when brewed produce a tea with a strong lemony taste without much of the sourness of lemon, a popular after-dinner drink in Peru. Jambu is a flowering herb, popular in Brazil, that when consumed in the form of fresh leaves, has a grassy taste followed by a strong tingling sensation (nicknames include the “toothache plant”, “Szechuan buttons”, and “buzz buttons”), and contains at least one active agent, spilanthol. Some of the products disclosed herein comprise a beverage, especially in soda form, prepared by mixing brews of Hierba Luisa and Jambu, with the use of coca extract to moderate any sour or tingling sensations.

### Other Nutritional Supplements and Additives

A variety of other nutritional supplements and additives can be added to one or more of the products disclosed herein, especially those supplements and additives that do not significantly alter taste, and that do not add significant amounts of sugar or fats. Such additions are optional.

Supplementing the Nutrients in Coca Leaves. Present in coca leaves are a variety of vitamins (e.g., A, B1, B3, B6, C, biotin, carotenes) and minerals (e.g., calcium, copper, chromium, iron, magnesium, sodium), as well as other chemicals with positive health benefits, such as caffeine, nicotine and/or polyphenols. Additional amounts of any of these chemicals can be added to the products disclosed herein.

N-acetylcysteine. For many embodiments of food products disclosed herein, consumers of such food products will be exposed to minor amounts of the main coca alkaloid, benzoylmethylecgonine. The amounts in any one serving of such food products will be similar to that of a few cups of coca tea—five to ten milligrams of benzoylmethylecgonine. Little of the benzoylmethylecgonine is absorbed into the blood while in the oral cavity, and when swallowed, little of the benzoylmethylecgonine is absorbed into the blood while in the gastrointestinal tract (typically on the order of 1 milligram), since much of the benzoylmethylecgonine is broken down in the hot, wet, acidic environment of the stomach. This use of coca extract does not lead to addiction (historically, there have been no reports of addiction to coca tea), and any slight “cravings” can be countered with addition of an over-the-counter nutritional supplement, n-acetylcysteine. N-acetylcysteine, in multi-gram amounts, has been used to treat addictions to cocaine and tobacco, and in hundreds of milligrams to multi-gram amounts for other conditions (ibuprofen overdose, flu symptoms). Those amounts of n-acetylcysteine can be added to the produces disclosed herein.

Phytosterols. Phytosterols are steroid compounds similar to cholesterol found in fruits and vegetables with reported abilities to reduce LDL cholesterol (the “bad” cholesterol) and total plasma cholesterol levels. Recent phytosterol compositions have been engineered to be dispersed in water-based products (see U.S. Pat. No. 8,460,738 and U.S. Patent Application 20120282368). Phytosterols can be added to the products disclosed herein.

L-theanine. L-Theanine is a non-protein amino acid found most commonly in green tea. L-Theanine has been shown to increase production of dopamine in the brain. The science is still unclear as to theanine's effect on serotonin production, which would help reduce levels of perceived stress. L-Theanine can be added to the products disclosed herein. L-Theanine has reported to also have some bitter masking effects.

Lithium. In recent years, lithium aspartate and lithium orotate are gaining recognition as supplements that might safely decrease signs of brain aging, and slow dementia. Both are available as over-the-counter supplements, and can be added to the products disclosed herein.

Other Supplements and Additives. Other nutritional supplements and additives that can be added to the products disclosed herein include: taurine, an anti-oxidant (for example, 500 to 1000 milligrams); mulberry (though to have beneficial effects on blood sugar, and high amounts of anti-oxidants); xanthohumol, a polyphenol with some anti-viral, anti-cancer, and anti-inflammatory properties; hesperidins, a citrus flavanone glycoside; glycomacropeptide (GMP), a protein source that does not contain phenylalanine and has hunger suppression effects; alpha lipoic acid, which may have blood sugar-regulating properties; a balanced mix (which can be 4:1 to 1:4) of the fatty acids omega-3 (an anti-inflammatory, some such acids being ALA, EPA and DHA, and preferably free of mercury present in some fish used to prepare omega-3 oils, with the longer-chain omega-3s from animal protein sources thought to have more health benefits) and omega-6 (an inflammatory) [see Simop2008]; soy lecithin—a popular food emulsifier (often in chocolate products), polysorbate 80, gum arabic, and other emulsifiers; tocopherol (a source of Vitamin E with freshening properties), vanilla/vanillin, which is rich in antioxidants, taurine, an amino acid added to energy drinks; artificial flavors; probiotic cultures such as those based on lactobacillus genus, and those based on the bifidobacteria genus, both of which have been reported to help break down cocoa into anti-inflammatory compounds; methylsulfonylmethane; L-lysine; and green tea extracts.

Carrageenan is a non-caloric non-digestible soluble fiber that can also be added to the products disclosed herein. Carrageenan is a thickener that gives low-fat foods a fuller taste (such as half & half creamers), while not altering taste, and is added to products such as yogurt, chocolate, ice cream, soups and toothpaste. Other thickeners include alginate (from seaweed), pectin (from fruits) and alginate-pectin.

In another embodiment, cinnamon powder or liquid can be added to the cocoa products disclosed herein, especially those with any sugar added. Some studies have shown that daily consumption of cinnamon can improve insulin resistance and blood glucose control.

The Center for Science in the Public Interest (CSPI) maintains a list of over 150 food additives, available at: http://www.cspinet.org/reports/chemcuisine.htm#safety-summary. Safety ratings are provided as well. Any of these additives, not already mentioned above, can be used in some of the products disclosed herein.

### Foodstuffs of the Invention As Vehicles for Delivering Medications

The cocoa-based foodstuffs with an extract of coca leaf or at least one coca alkaloid serving as the debittering agent can be used for preventing, treating, or improving any disease or condition that coca leaf, extracts of coca leaf, or coca alkaloids are known to benefit, including but not limited to liver diseases, diabetes, diseases linked to high cholesterol, erectile dysfunction (ED), multiple sclerosis (MS), cancer, epilepsy, fatigue, stress, immune system problems, prostate conditions, and aging. In some embodiments, the cocoa-based foodstuffs of the invention, further comprise SP grams of at least one supplement selected from the group consisting of: phytosterols, L-theanine, n-acetylcysteine, 5′-ribonucleotides, taurine, mulberry, xanthohumol, hesperidins, glycomacropeptide, alpha lipoic acid, omega-3 fatty acids, omega-6 fatty acids, soy lecithin, gum Arabic, polysorbate 80, tocopherol, vanilla, vanillin, taurine, artificial flavors, probiotic cultures, green tea extracts, carrageenan, cinnamon, saw palmetto, rhodiola, red yeast rice, strawberries, and ginseng, wherein the ratio AL/(C+F+S+SP) is approximately equal to or less than the ratio of the maximum allowable amount of coca alkaloid that can be legally used in said foodstuff, and where use of such supplements is optional.

Cocoa, Coca, and Coffee for Liver/diabetes. Coffee is one of the world's most popular drinks, and caffeine is the worlds' most widely consumed psychoactive drug (a methylxanthine very similar to cocoa's theobromine). In recent years, regular coffee consumption, preferably free of sugar, has been linked to a variety of health benefits, including lowering the risks of liver disease and type 2 diabetes (see “11 reasons why you should drink coffee every day”, http:/www.huffingtonpost.com/2013/10/17/coffee-health-benefits_n_4102133.html). A popular combination, not surprisingly, are mocha drinks—combinations of coffee and chocolate. Another embodiment of the products disclosed herein comprises mixing coffee with cocoa and extracts of coca leaf.

Cocoa, Coca, and Red Yeast Rice for Reducing Cholesterol, ED and MS. Red yeast rice is a reddish purple fermented rice, which acquires its color from being cultivated with the mold Monaseus purpureus. A chemical obtained from Monascus, monacolin K, was shown to be identical to the cholesterol-lowering chemical lovastatin (1200-2400 milligrams a day of red yeast rice can contain 5 milligrams of lovastatin, as opposed to the 20 to 80 milligrams a day prescribed medically). Additionally, in 2014, medical news reported that statins also help improve erectile dysfunction (ED), and that high doses of simvastatin helped with one form of multiple sclerosis (MS). Another embodiment of the products disclosed herein comprises mixing extracts of the red yeast rice with cocoa and extracts of coca leaf, with or without the monacolin K as regulated by local health authorities.

Cocoa, Coca and Strawberries for Treating Cancer. Chocolate-covered strawberries has been a romantic favorite for centuries. Mixtures of chocolate and strawberry ice cream (usually with vanilla ice cream, and more fun with a banana to form the classic Banana Boat) have been popular for just as long as a summer treat. They mix well. Recent studies show that consumptions of large amounts of strawberry powder (for example, 60 grams per day) can reduce the risk of, or prevent, some types of cancer [see Suh2012]. Another embodiment of the products disclosed herein comprises mixing extracts of the strawberry with cocoa and extracts of coca leaf, and optionally, coloring agents. Similarly, another embodiment of the products disclosed herein comprises mixing extracts of blueberries with cocoa and extracts of coca leaf. At least one medical study reported that consuming 22 grams of blueberries per day resulted in a 5% reduction in systolic blood pressure and diastolic blood pressure.

Cocoa, Coca, Epilepsy and More Coca. Some years ago, a suppressed government study surprisingly discovered that extracts of coca leaf can reduce the symptoms of epilepsy. Five long-term chewers of coca leaf were monitored after their sudden termination of their chewing. Because coca chewing is not addictive, for three of the chewers, nothing happened. The other two eventually displayed signs of shaking and excess salivation, which lead to the discovery of an epileptic condition for these two patients. Quickly dismissed was their coca chewing being the cause, but rather, that their coca chewing was acting as a treatment. Such a treatment can be impractical outside of coca chewing cultures. However, versions of the products disclosed herein, with extra coca extract, can be used to help treat epilepsy.

Cocoa, Coca and Rhodiola for Reducing Fatigue and Stress. A legal, non-addictive, prescription drug (Schedule IV, easy to obtain) of growing popularity for fighting fatigue and improving mental performance (much used by “Air Force pilots, emergency room doctors, and Silicon Valley entrepreneurs”) is modafinil (brand name is Provigil), which acts similarly to an amphetamine. Extracts of the Rhodiola rosea plant provide effects similar to that of modafinil. Such extracts of Rhodiola can be accompanied with ginseng extracts to help reduce stress, Another embodiment of the products disclosed herein comprises mixing extracts of the Rhodiola plant with cocoa and extracts of coca leaf.

Cocoa, Coca, and Ginseng for Treating Immune System Problems. Ginseng is a family of plants with fleshy roots which contain one or more ginsenosides, which have shown some effective in treating immune system problems and helping to improve blood sugar chemistry While ginseng is popular in Asian cultures where it is well known, it has had less acceptance in the Americas due to its unfamiliar flavors. However, a recent study showed that chocolate can be added to ginseng preparations to make them more palatable [see Chung2012]. Another embodiment of the products disclosed herein comprises mixing extracts of ginseng with cocoa and extracts of coca leaf, and optionally, coloring agents.

Cocoa, Coca, and Saw Palmetto for Prostate Conditions. Saw palmetto is a plant with a fruit that has been used as a medicine, with some reported successes, for treating conditions of the prostate. One form of saw palmetto for such use is powder in capsule which can be swallowed as is, or used to make a tea. Another embodiment of the products disclosed herein comprises mixing extracts of saw palmetto powder with cocoa and extracts of coca leaf.

Cocoa, Coca, and PABA and DMAE for Aging. For many years, there has been a debate about the use of procaine as an anti-aging compound, a use put forth by a Romanian scientist, Ana Aslan in the 1950s, though has encountered FDA opposition for years. It is thought that such effects of procaine are due to its breakdown products, PABA (para-aminobenzoic acid) and DEAE (diethylaminoethanol). Closely related to DEAE is DMAE (dimethylaminoethnol). Another embodiment of the products disclosed herein comprises mixing PABA and DMAE (or DEAE where available) with cocoa and extracts of coca leaf

Substituting Valerian Root Extracts for Coca Leaf Extracts. For products similar to those described in the last eight paragraphs, where coca extract and coca are mixed with other natural materials that have health benefits, a variety of related products can be manufactured by substituting extracts of coca leaf with extracts of Valerian root, along with any flavorings such as for strawberry or vanilla or cherry. A general fruity flavor can be created by including any of the following additives: furaneol, phenylacetaldehyde, ethyl-2-methylpropanoate, ethyl-2-methylbutanoate, ethyl-2-methylbutanoate, and combinations of any thereof.

Substituting Hibiscus Extracts for Coca Leaf Extracts. For products similar to those described in the last nine paragraphs, a variety of related products can be manufactured by substituting extracts of coca leaf or Valerian root with extracts of Hibiscus flower, along with any flavorings such as for strawberry or vanilla or cherry. A variety of health benefits are obtained from Hibiscus, such as providing diuretic effects, treating mild hypertension, and having bioflavonols that can prevent an increase in LDL cholesterol.

### Commercial Production

### Large Scale Manufacturing

The foodstuffs provided by the present invention can be produced on a large scale, i.e., a scale suitable for commercial distribution, using methods and materials familiar to those having skill in the art. Any of a variety of coca leaves, for example, those used in brands of mate de coca, can be brewed on an industrial scale to prepare extracts of the coca leaf. Coca leaves, in large quantities, can be brewed industrially, and the brew can be distilled and dried. Or the alkaloids can be obtained synthetically from a chemical supplier. The resulting liquid or powder form can then be mixed with cocoa powder, and other ingredients, using any of a variety of mixers, such as jacketed Hobart mixers. Alternatively, liquid cocoa can be mixed with the brewed mate, with the resulting mixture distilled and dried. Alternatively, liquid cocoa can be mixed with a liquid extract of coca leaves, with the resulting mixture distilled and dried. Liquid or solid extracts of coca leaves can be added to traditional chocolate products, recipes and production methods, such as those disclosed in “Sugar Confectionery and Chocolate Manufacture”, by R. Lees and E. B Jackson, first published in 1973, and incorporated herein by reference in its entirety and for all purposes.

### Packaging to Preserve Freshness of Coca Tea and Coca Extracts

Coca plants typically require five to six years before the leaves are sufficiently mature for consumption. Not all coca teas have the same tastes, and coca tea leaves can go stale (or be damaged after harvest by exposure to rain or a damp atmosphere, which can lead to growth of mold which breaks down alkaloids in the leaves). The freshness of extracts from coca leaf is a factor in the masking of bitterness of cocoa. Thus, one embodiment of the products disclosed herein is to seal a mixture of cocoa powder and coca leaf extract in a non-air-permeable packet, for example, the laminate of paper and plastic packet used for Tazo teas, or the packets used to package Swiss Miss Hot Chocolate. One such packet can be those similar to the Hot Cocoa K-cups used with Keurig brewing machines, which retail in 2013 for around US $0.75.

### Acceptable Levels of Coca Alkaloid Under Global Law

The UN regulations for use of coca alkaloids in medicinal products (1961 Single Convention on Narcotic Drugs), for example, that can be exported from countries such as Bolivia and Peru, require that there be no more than 0.1 percent of coca alkaloid in the product. For example, the combination of two tablespoons of cocoa and coca extracts from two tea bags of coca tea, satisfies this regulation. Two tablespoons of cocoa powder can weigh approximately 14 grams, or 14,000 milligrams. Thus, 0.1 percent of that weight is 14 milligrams. One cup of coca tea made from one bag of coca tea contains approximately 5 milligrams of coca alkaloid (see, for example, “Identification and quantitation of alkaloids in coca tea”, Forensic Science International, February 1996, 179-189), with two to three bags thus contributing 10 to 15 milligrams of coca alkaloid to the 14 grams of cocoa powder, with the limits of the regulations of the UN. Thus, in an alternative method of preparation, extracts of coca leaf can be added to cocoa in proportion allowed by UN regulation, for use in preparing the products disclosed herein. For such products, for every C grams of unsweetened cocoa, up to AL grams of coca alkaloids can be used, where AL/C is approximately 0.001. Taste tests show that some prefer the combination of one tablespoon of cocoa powder with two or more bags of coca tea, leading to an amount of a coca alkaloid that can be twice the global limit. Products based on this combination can be sold in countries where coca tea is now, or will be, legally sold (or additives such as protein can be added to reduce the ratio).

### Regulated Retail Distribution

In some countries, some of the products disclosed herein will be required to be sold as prescription medications, for example, sold at a pharmacy. One system for regulated retail distribution for some of the products disclosed herein comprises using retailers such as Starbucks, which already distribute teas and chocolate beverages at a large number of convenient locations, and which could apply to governmental bodies to operate a “mini-pharmacy” operation at their retail locations.

For example, Starbucks and Dunkin'Donuts, at their manufacturing facilities, under government control, can prepare packets of mixtures of cocoa, coca extract and other ingredients, and seal them for shipment to their retail locations, where at the retail location, a customer can order a beverage using the packets. Then, with or without a prescription (depending on local laws), customers can buy fully prepared versions of some of the products disclosed herein, presumably to consume at the retail location, or take back to their homes or offices to consume there.

### EXAMPLES

The following examples are offered for the purpose of illustration and not limitation. The details of the examples do not in any way limit the description of the invention. Four exemplary books, “The New Taste of Chocolate” by Maricel Presilla (Ten Speed Press, 2009); “Seriously Bittersweet: The Ultimate Dessert Maker's Guide to Chocolate” by Alice Medrich (Workman Publishing, 2013) and “Chocolate and The Art of Low-Far Desserts” also by Alice Medrich (Warner Books, 1994); and “Superfoods for Life: Cacao” by Matt Ruscigno (Fair Winds Press, 2014), have a wide variety of recipes using cocoa and chocolate (along with good introductions to the history, farming and medical benefits of cacao). Those skilled in the art of preparing food products with cocoa can use the recipes in these books, and similar books, with the methods disclosed herein to reduce the amount of sugar used in the food products.

### EXAMPLE 1

### General Beverage Preparation

1. Prepare hot water, typically to a temperature between 70° C. and 100° C.

2. Brew two to four bags of coca tea (e.g. ECOCARANAVI® brand) in the hot water (e.g. about 1 to 2 cups), typically for a period of between 3 minutes and 6 minutes.

3. Remove the tea bags, and add two tablespoons of unsweetened cocoa (approximately 14 to 15 grams, depending on the brand).

4. Stir until well mixed.

5. Optionally, add in sweeteners, flavorings, and nutritional supplements. For example, one or more teaspoons of liquid lecithin can be added (available, for example, from Fearn Natural Foods, Mequon, Wisconsin). For example, salt and vanilla can be added, as they are in most forms of chocolate—BREICK® unsweetened cocoa powder available in Bolivia has added vanilla.

6. Drink.

The number of bags of coca tea used is at the taste preference of the consumer, with those who like a “stronger” taste using fewer bags of tea. This method can be productized, for example, by combining in a larger tea bag the contents of the one to four bags of coca tea, two tablespoons of unsweetened cocoa, and optionally, some salt, vanilla and/or a food surfactant (for example, lecithin, or those based on inulin) to ease the diffusion of the cocoa into the water.

### EXAMPLE 2

### Dry Mix Powdered Beverage

1. Using standard manufacturing techniques, prepare 148 grams (14.8 grams×10) of unsweetened cocoa powder.

2. Brew 20 to 40 bags of coca tea (e.g., ECOCARANAVI® brand) in hot water (e.g. about 20 cups) at a temperature between 70° C. and 100° C. as described in Example 1. Separate the tea leaves and other solids from the liquid.

3. Dehydrate the liquid portion, leaving a powdered extract of coca leaf; or, obtain the equivalent weight of powdered extract from a commercial supplier. Circa 2015, NovoAndina International (www.novoandinastore.com) was selling a concentrated powdered extract of coca leaf, “Caranavi Extract: Full Alkaloids Coca”, and a liquid extract, “Liquid [Coca] Extract: Alcohol Free”. Either product can be used in the embodiments disclosed herein.

4. Mix powdered extract with unsweetened cocoa powder, such as Hershey's UNSWEETENED COCOA®, or Extra Rich Organic Cacao Powder from Z Natural Foods (which is approximately 50% by weight of fat)

5. Optionally, add in and mix sweeteners, flavorings, and nutritional supplements. Such additional items mixed in can include those typically found in hot cocoa mix products, such as one or more of the following: nonfat dry milk, whey, salt, potassium and sodium phosphate, cellulose gum, mono- and diglycerides, sodium caseinate, and soy lecithin.

6. Package for sale using standard packaging techniques, for example, the packaging used for Hershey's UNSWEETENED COCOA®.

### EXAMPLE 3

### Use of Powdered Beverage Product

1. Prepare hot water, typically to a temperature between 70° C. and 100° C.

2. Add approximately two tablespoons of the powdered product of Example 2.

3. Stir until well mixed.

4. Optionally, add in sweeteners, flavorings, and nutritional supplements.

5. Drink.

### EXAMPLE 4

### Beverage Product Preparation

1. Using standard manufacturing techniques, for example, prepare 148 grams (14.8 grams×10) of unsweetened cocoa powder.

2. Mix about 100 milligrams (20 mg×5) to 200 mg (40 mg×5) of benzoylmethylecgonine with the unsweetened cocoa powder.

3. Optionally, add in and mix about 40 milligrams (20 mg×2) to 80 mg (40 mg×2) of ecgonine methyl ester.

4. Optionally, add in and mix about 10 milligrams (20 mg×0.5) to 20 mg (40 mg×0.5) of benzoylecgonine.

5. Optionally, add in and mix sweeteners, flavorings, and nutritional supplements.

6. Package for sale using standard packaging techniques, for example, the packaging used for Hershey's UNSWEETENED COCOAS. Optionally, milk can be added and the product sold as a beverage.

### EXAMPLE 5

### Beverage Product Preparation

A cup of hot cocoa-tea was made using coca tea. First, to a cup of hot water was added four bags of HERBI® (Peru) or ECOCARANAVI® (Bolivia) coca tea, and the tea bags were kept in the hot water for approximately four minutes. After boiling for the desired period the tea bags were removed, and two tablespoons of unsweetened cocoa powder were mixed into the hot tea. The result was a chocolate-tasting drink, with both a less-intense and less-lingering bitterness taste. The beverage has a diminished smell of bitterness, the initial sip has a diminished bitterness, and subsequent sips have a diminished bitterness. With typical amounts of stirring, no clumping was observed.

### EXAMPLE 6

### Taste Test

Each of four volunteer subjects was given about two tablespoons of unsweetened cocoa in about 35 milliliters of water at a temperature of about 90° C. Each subject was allowed to drink the mixture and then asked to describe their experience of the taste of the drink. Each subject described the taste as bitter, some subjects complaining that the bitterness was particularly unpleasant.

The four subjects were then given the same amount of a coca-cocoa preparation made as described in Example 1. Each subject tasted the preparation and was asked about their experience of the taste. Each subject noticed a greatly reduced bitterness, with one subject reporting that they found the drink especially enjoyable.

### EXAMPLE 7

### Cold Brewing

Two bags of coca tea (e.g., ECOCARANAVI® brand) were brewed in two cups of cold water for approximately five hours while being stored in a refrigerator (approximately 5° C.). The brewed tea was removed from the refrigerator, and one tablespoon of unsweetened HERSHEY's UNSWEETENED COCOA® was added. The resulting taste was less bitter than the taste of adding one tablespoon the cocoa to two cups of cold water.

### EXAMPLE 8

### Addition of a Protein Supplement

To a beverage mixture such as described in Example 5 was added two tablespoons of soy powder. With reasonable amounts of stirring, no clumping was observed. There was little change in cocoa taste or bitterness levels, while adding some texture and a bit of graininess, with the soy also adding about two grams of protein and a gram of fat. Such mixtures using soy are a basis for more solids forms of some of the products disclosed herein. Alternatively, coca tea can be brewed in soy milk, to which cocoa powder is added.

### EXAMPLE 9

### Use of Whole Coca Leaf

The content of a bag of coca tea is basically finely ground up coca leaf. For example, twelve whole coca leaves (from the Yungas region of Bolivia) were placed into a cup, to which was added hot water, and the leaves were allowed to brew for approximately 12 minutes. Then one tablespoon of Hershey's UNSWEETENED COCOA® was added. A similar level of reduction of bitterness was achieved as compared to preparations using bags of coca tea.

Similarly, for example, twelve whole coca leaves (from the Chapare region of Bolivia) were placed into a cup, to which was added hot water, and the leaves were allowed to brew for approximately 12 minutes. Then two tablespoons of Hershey's UNSWEETENED COCOA® was added. A similar level of reduction of bitterness was achieved as compared to preparations using bags of coca tea, though with less of coca flavor present.

### EXAMPLE 10

### Use of Cocoa and Coca Flour (Harina)

Some companies produce coca flour (harina). For example, Inal Mama of Bolivia manufactures and sells COCA ZERO® coca flour, while Macro Natura of Peru sells HARINA DE COCA PREMIUM™. In one experiment, one tablespoon of Hershey's cocoa powder was mixed with one teaspoon of COCA ZERO® coca flour, to which one cup of hot water was added. In a related experiment one tablespoon of cocoa powder was mixed with two teaspoons of COCA ZERO®. The reduction of bitterness was similar to that found by using one or two tea bags, respectively. The taste of the mixture of cocoa and coca flour was somewhat different than that of brewing with tea bags, as the coca flour contributes more leaf particulate to the mixture.

### EXAMPLE 11

### Preparing Coca/Cocoa Frosting

1. 6 tablespoons of (cocoa) butter

2. 5 tablespoons of milk

3. 12 tablespoons of unsweetened cocoa

4. Coca leaf extract from 24 bags of coca tea, or the equivalent

5. 1 Teaspoon Vanilla

To prepare, cream the butter in a small mixing bowl. Add cocoa and coca extract, alternating with milk. Beat to spreading consistency (adding additional tablespoon of milk for creamier consistency). Blend in vanilla.

### EXAMPLE 12

### Preparing Coca Chocolate

1. 12 tablespoons of (cocoa) butter

2. 10 tablespoons of milk

3. 32 tablespoons of unsweetened cocoa

4. Coca leaf extract from 64 bags of coca tea, or the equivalent

5. 4 tablespoons of flour (or milk powder)

To prepare, put cocoa and butter into a bowl, and blend them into a fine paste (either by hand, or with a food processor); you can melt the butter beforehand. Next, put one cup of water into a pot and the just prepared paste, and mix and heat until hot but not boiling. Next, put resulting liquid back into the bowl, and mix in milk, flour and coca leaf extract. Next, mix by hand or processor until you have a relatively smooth composition. Pour the mixture into molds of any shape, and allow to cool in a refrigerator for at least six hours.

### EXAMPLE 13

### Sweet Potato Chocolate Milk

1. 2 cups of cubed sweet potato

2. 4 cups of water

3. 4 tablespoons of unsweetened cocoa

4. Coca leaf extract from 8 bags of coca tea, or the equivalent

To prepare, fill a medium-sized saucepan with water and bring to a boil. Add sweet potato and cook, covered for eight minutes. Drain the potatoes and place in a high powered blender, along with four cups of water. Blend for one minute, until completely pulverized.

Before or after blending, add in the coca leaf extract. Run final mixture through a nut milk bag, though for a thicker drink, skip this step of the process. Optionally, add in and mix sweeteners, flavorings, and nutritional supplements.

### EXAMPLE 14

### Minimizing Use of Coca Alkaloids

1. Prepare one tablespoon of unsweetened cocoa powder

2. Mix in one to two teaspoons of brewed coca tea

3. Allow to dry

4. Optionally, mix in a tablespoon of milled soy lecithin and one or two more teaspoons of brewed coca tea

The resulting food product is a mix of powder and clumps, and can be eaten with little to no unpleasantness due to the bitterness of the untreated cocoa powder. Addition of common chocolate ingredients (e.g., a bit of vanilla, salt, flavoring) and a bulking agent (e.g., lecithin), creates a foodstuff quite similar in taste, color, odor and texture of typical chocolates, without requiring sugar or fat.

The methods, products, consumable components and packaging of the following U.S. Patents or Patent Applications are incorporated by reference, especially where use of sweeteners in these references is reduced or eliminated by the use of coca extracts: U.S. Pat. No. 8,709,524, “Process for preparing red cocoa ingredients, red chocolate and food products”; U.S. Pat. No. 8,507,021, “Reduced fat chocolate”; U.S. Pat. No. 7,919,135, “Steeped cocoa beverages”; U.S. Pat. No. 8,119,182, “Chocolate drinks and method for their production”; U.S. Pat. No. 8,137,725, “Organoleptically enhanced white chocolate”, U.S. Pat. No. 8,119,182, “Chocolate drinks and method for their production”, U.S. H1620, “Dry chocolate flavored beverage mix”; U.S. Patent Application 20030177089, “Non-surgical method for breast augmentation” [using cocoa butter]; and U.S. Patent Application 20130004604, “Dark chocolate delivery system for a combination of dietary supplements and pharmaceuticals”.

### CONCLUSION

Thus, the present invention will be seen by those having ordinary skill in the art to provide an important advance in food science and nutrition by enabling the production of foodstuff's having the considerable health benefits of cocoa with little to none of its bitterness. Using the disclosure herein, a wide variety of foodstuffs can be made, including, but not limited to, hot and cold beverages, food bars, cakes, candies, and the like. The foodstuffs can include additional beneficial substances, such as, but not limited to, proteins, medicaments, particularly natural medicaments, and vitamins.

The above description of the embodiments, alternative embodiments, and specific examples, are given by way of illustration and are not intended to be limited to the specific form set forth herein. Additionally, although a feature may appear to be described in connection with a particular embodiment, one skilled in the art would recognize that various features of the described embodiments can be combined in accordance with the invention. Moreover, aspects of the invention describe in connection with an embodiment may stand alone as an invention.

Moreover, it will be appreciated that various modifications and alterations can be made by those skilled in the art without departing from the spirit and scope of the invention. The invention is not to be limited by the foregoing illustrative details and embodiments shown, but is to be accorded the widest scope consistent with the claims along with their full scope of equivalents. The appended patent claims are intended to be construed to include all such embodiments and equivalent variations.

### BIBLIOGRAPHY

[Aidoo2013] Roger Aidoo, “Industrial manufacture of sugar-free chocolate—applicability of alternative sweeteners and carbohydrate polymers as raw materials in product development”, Trends in Food Science & Technology, volume 32 n2, August 2013, pages 84-96
[Amae2013] B.T. Amaechi, et al., “Remineralization of artificial enamel lesions by theobromine”, Caries Research, volume 47 no 5, May 2013, pages 399-405
[Bayard2007] Vincent Bayard et al., “Does flavanol intake influence mortality from nitric oxide-dependent processes? Ischemic heart disease, stroke, diabetes mellitus, and cancer in Panama”, Int. J. of Medical Sciences, volume 4(1), 2007, pages 53-58
[Blum2010] Simone Blumberg et al., “Quantitative studies on the influence of the bean roasting parameters and hot water percolation on the concentrations of bitter compounds in coffee brew”, Journal of Agricultural and Food Chemistry, volume 58 n6, March 2010, pages 3720-3728
[Bogard2010] Bas van den Bogaard et al., “Effects on peripheral and central blood pressure of cocoa with natural or high-dose theobromine”, Hypertension, volume 56, November 2010, pages 839-946
[Brick2014] Adam Brickman et al., “Enhancing dentate gyrus function with dietary flavonols improves cognition in older adults”, Nature Neuroscience, volume 17, December 2014, pages 1798-1803
[Chung2012] Hee Sook Chung and Soo-Yeun Lee, “Modification of ginseng flavors by bitter compounds found in chocolate and coffee”, Journal of Food Science, volume 77 n6, June 2012, pages 8202-210
[Fernan2015] Elisa Fernandez-Millan et al., “Cocoa-rich diet attenuates beta cell mass loss and function in young Zucker diabetic fatty rats by preventing oxidative stress and beta cell apoptosis”, Molecular Nutrition & Food Research, Epub January 2015
[Franco2013] Rafael Franco, “Health benefits of methylxanthines in cacao and chocolate”, Nutrients, volume 5, 2013, 4159-4173
[Gaude2011] Nicole Gaudette, “Charactersation and optimisation of the flavour of health-promoting, plant-derived bitterants in functional beverages”, PhD Thesis, Brock University, 2011
[Jenkins1996] Amanda Jenkins et al., “Identification and quantitation of alkaloids in coca tea”, Forensic Sci. Int., volume 77 n3, February 1996, 179-190
[Leon2009] Effendi Leonard et al., “Opportunities in metabolic engineering to facilitate scalable alkaloid production”, Nature Chemical Biology, volume 5 n5, May 2009, pages 292-300
[Neufin2013] Nicole Neufingerl, “Effect of cocoa and theobromine consumption on serum HDL-cholesterol concentrations: a randomized controlled trial”, American Journal of Clinical Nutrition, volume 97 n6, June 2013, pages 1201-1209
[Penny2009] Mary Penny et al., “Can coca leaves contribute to improving the nutritional status of the Andean population?”, Food Nutrition Bulletin, volume 30 n3, September 2009, pages 205-216
[Pick 1986] William Pickenhagen and Paul Dietrich, “Identification of the bitter principle of cocoa”, Helvetica Chimica Acta, volume 58 n4, 1975, pages 1078-1086
[Risnr2008] Charles Risner, “Simultaneous determination of theobromine, (+)-catechin, caffeine, and (−)-epicatechin in Standard Reference Material Baking Chocolate 2384, cocoa, cocoa beans and cocoa butter”, Journal of Chromatographic Science, volume 46, November/December 2008, 892-899
[Rover2007] Sophie Rovner, “Tweaking coffee's flavor chemistry”, Chemical & Engineering News, volume 85 n38, 17 Sep. 2007, page 32-34
[Schieb2000] Peter Schieberle, “The chemistry and technology of cocoa”, in Caffeinated Beverages, ACS Symposium Series, 2000, pages 262-275
[Simop2008] Artemis Simopoulos, “The importance of the omega-6/omega-3 fatty acid ratio in cardiovascular disease and other chronic diseases”, Experimental Biology and Medicine, volume 233 n6, June 2008, pages 674-688
[Sorond2008] Farzanch Sorond, “Cerebral blood flow response to flavonol-rich cocoa in healthy elderly humans”, Neuropsychiatric Disease and Treatment, volume 4 n2, April 2008, 433-440
[Stark2005] Timo Stark et al., “Sensory-guided decomposition of roasted cocoa nibs (Theobroma cacao) and structure determination of taste-active polyphenols, J. Agric. Food. Chemistry, vol. 53, 2005, pages 5407-5418
[Suh2007] Nanjoo Suh and John Pezzuto, “Strawberry field forever?”, Cancer Prevention Research, v5 nl, January 2012, pages 30-33
[Swith2013] Susan Swithers, “Artificial sweeteners produce the counterintuitive effect of inducing metabolic derangements”, Trends in Endocrinology and Metabolism, v24 n9, 2013, pages 431-41
[Vlach2007] C. Vlachopoulos et al., “Relation of habitual cocoa consumption to aortic stiffness and wave reflections, and to central hemodynamics in healthy individuals”, Am. J. Cardiology, v 10. 2007, pages 1473-1475
[Volk2014] B. Volk et al., “Effects of step-wise increases in dietary carbohydrate on circulating saturated fatty acids and palmitoleic acid in adults with metabolic syndrome”, PLOS One, November 2014.
Bitter alkaloid containing consumables comprising bitter blockers U.S. Patent Application 2011/0086138
Continuous multi-microencapsulation process for improving the stability and storage life of biologically active ingredients U.S. Patent Application 2007/0077308
Steeped cocoa beverages U.S. Patent Application 2007/0254068
Dark chocolate delivery system for a combination of dietary supplements and pharmaceuticals PCT Application WO 2011/072224

Product and method for oral administration of nutraceuticals PCT Application WO 2006/063219

What is claimed is:

1. A method, comprising:
obtaining AL grams of a coca leaf extract from coca leaves of a plant that is a member of the plant genus Erythroxylym coca;
deriving a cocoa-based foodstuff by mixing C grams of a bitter, fat-free, unsweetened cocoa, F grams of a fat, S grams of a sweetener, and SP grams of a supplement; and
de-bittering the cocoa-based foodstuff by adding the AL grams of the coca leaf extract,
wherein a ratio of the AL grams of the coca leaf extract to a sum of the C grams of the bitter, fat-free, unsweetened cocoa, the F grams of the fat, the S grams of the sweetener, and the SP grams of the supplement is less than a maximum allowable ratio, and
wherein a sum of the F grams of the fat and the S grams of the sweetener is less than the C grams of the bitter, fat-free unsweetened cocoa.

2. The method of claim 9, the obtaining further comprising:
brewing the coca leaves in water for ten to twenty minutes at a temperature range from 70 degrees Celsius to 100 degrees Celsius,

3. The method of claim 9, the obtaining further comprising:
chemically extracting the coca leaf extract from the coca leaves using a solvent.

4. The method of claim 9, the obtaining further comprising:
cold brewing the coca leaves in cold water.

5. The method of claim 9, further comprising:
washing the coca leaves in an alcohol; and
drying the coca leaves to remove the alcohol.

6. The method of claim 9, wherein the supplement is selected from a group consisting of: phytosterols, L-theanine, N-acetylcysteine, 5′-ribonucleotides, taurine, mulberry, xanthohumol, hesperidins, glycomacropeptide, alpha lipoic acid, omega-3 fatty acids, omega-6 fatty acids, (soy) lecithin, gum Arabic, polysorbate 80, tocopherol, vanilla, vanillin, taurine, artificial flavors, probiotic cultures, green tea extracts, carrageenan, cinnamon, saw palmetto, rhodiola, red yeast rice, strawberries, and ginseng.

7. The method of claim 9, wherein the coca leaf extract is selected from a group consisting of: benzoylmethylecgonine, methylecgonine, methylecgonine cinnamate, benzoylecgonine, truxilline, hydroxytropacocaine, tropacocaine, ecgonine, cuscohygrine, dihydrocuscohygrine, nicotine, and hygrine.

8. The method of claim 9, wherein the fat is selected from a group consisting of cacao butter, milk fat, plant oil, animal fat, or a fat substitute.

9. The method of claim 9, wherein the sweetener is selected from a group consisting of sugar, agave, jiggery, honey, molasses, lucuma, tagatose, inulin, and capuacu.

10. The method of claim 9, further comprising:
adding a flavor enhancing agent to the cocoa-based foodstuff, wherein the flavor enhancing agent is selected from a group consisting of methyl benzoate, methyl cinnammate, and truxillic acid dimethyl ester.

11. The method of claim 9, further comprising:
adding a vitamin to the cocoa-based foodstuff, wherein the vitamin is selected from a group consisting of vitamin A, vitamin B1, vitamin B3, vitamin B6, and biotin.

12. The method of claim 9, further comprising:
adding a mineral to the cocoa-based foodstuff, wherein the mineral is selected from a group consisting of calcium, copper, chromium, iron, magnesium, and sodium.

13. A method, comprising:
obtaining AL grams of a coca leaf extract from coca leaves of a plant that is a member of the plant genus Erythroxylum novogranatense;
deriving a cocoa-based foodstuff by mixing C grams of a bitter, fat-free, unsweetened cocoa, F grams of a fat, S grams of a sweetener, and SP grams of a supplement; and
de-bittering the cocoa-based foodstuff by adding the AL grams of the coca leaf extract,
wherein a ratio of the AL grams of the coca leaf extract to a sum of the C grams of the bitter, fat-free, unsweetened cocoa, the F grams of the fat, the S grams of the sweetener, and the SP grams of the supplement is less than a maximum allowable ratio, and
wherein a sum of the F grams of the fat and the S grams of the sweetener is less than the C grams of the bitter, fat-free unsweetened cocoa.

14. The method of claim 21, the obtaining further comprising:
brewing the coca leaves in water for ten to twenty minutes at a temperature range from 70 degrees Celsius to 100 degrees Celsius.

15. The method of claim 21, the obtaining further comprising:
chemically extracting the coca leaf extract from the coca leaves using a solvent.

16. The method of claim 21, the obtaining further comprising:
cold brewing the coca leaves in cold water.

17. A method, comprising:
obtaining AL grams of a coca leaf extract from coca leaves of a plant that is a member of the plant genus Erythroxylum brevipes;
deriving a cocoa-based foodstuff by mixing C grams of a bitter, fat-free, unsweetened cocoa, F grams of a fat, S grams of a sweetener, and SP grams of a supplement; and
de-bittering the cocoa-based foodstuff by adding the AL grams of the coca leaf extract,
wherein a ratio of the AL grams of the coca leaf extract to a sum of the C grams of the bitter, fat-free, unsweetened cocoa, the F grams of the fat, the S grams of the sweetener, and the SP grams of the supplement is less than a maximum allowable ratio, and
wherein a sum of the F grams of the fat and the S grams of the sweetener is less than the C grams of the bitter, fat-free unsweetened cocoa.

18. The method of claim 25, the obtaining further comprising:
brewing the coca leaves in water for ten to twenty minutes at a temperature range from 70 degrees Celsius to 100 degrees Celsius.

19. The method of claim 25, the obtaining further comprising:
chemically extracting the coca leaf extract from the coca leaves using a solvent.

20. The method of claim 25, the obtaining further comprising;
cold brewing the coca leaves in cold water.
